(19) United States
(12) Patent Application Publication
(10) Pub. No.: US 2026/0101362 A1
(43) Pub. Date: Apr. 9, 2026

(54) DEVICE-TO-READER TRANSMISSION WITH MIDAMBLE

(71) Applicant: Samsung Electronics Co., Ltd., Suwon-si (KR)

(72) Inventor: Jeongho Jeon, San Jose, CA (US)

(21) Appl. No.: 19/334,779

(22) Filed: Sep. 19, 2025

Related U.S. Application Data
(60) Provisional application No. 63/704,900, filed on Oct. 8, 2024.

(51) Int. Cl. H04W 72/40; H04L 1/00

(52) U.S. Cl. CPC H04W 72/40; H04L 1/0008; H04L 1/0061

(57) ABSTRACT

Apparatuses and methods for a device-to-reader transmission with midamble. A method for an Internet of Things (IoT) device to communicate with a reader includes receiving a physical reader-to-device channel (PRDCH) from the reader. The PRDCH provides information related to a physical device-to-reader channel (PDRCH) transmission including at least a preamble format to prepend to the PDRCH, an interval for inserting one or more midambles in the PDRCH, an indicator for appending an additional midamble at an end of the PDRCH, and other device-to-reader (D2R) scheduling information. The method further includes determining, based on reception of the PRDCH, a transmission of the PDRCH to the reader, including the preamble format, whether to insert the one or more midambles, and whether to append the additional midamble and transmitting the PDRCH with a preamble and the one or more midambles.

### CROSS-REFERENCE TO RELATED AND CLAIM OF PRIORITY

The present application claims priority under 35 U.S.C. § 119(e) to U.S. Provisional Patent Application No. 63/704,900 filed on Oct. 8, 2024, which is hereby incorporated by reference in its entirety.

### TECHNICAL FIELD

The present disclosure relates generally to wireless communication systems and, more specifically, the present disclosure is related to apparatuses and methods for a device-to-reader transmission with midamble.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to a device-to-reader transmission with midamble.

In one embodiment, a method for an Internet of Things (IoT) device to communicate with a reader is provided. The method includes receiving a physical reader-to-device channel (PRDCH) from the reader. The PRDCH provides information related to a physical device-to-reader channel (PDRCH) transmission including at least a preamble format to prepend to the PDRCH between a short format and a long format, an interval for inserting one or more midambles in the PDRCH, an indicator for appending an additional midamble at an end of the PDRCH, and other device-to-reader (D2R) scheduling information. The method further includes determining, based on reception of the PRDCH, a transmission of the PDRCH to the reader, including the preamble format, whether to insert the one or more midambles, and whether to append the additional midamble and transmitting, based on the determination, the PDRCH with a preamble and the one or more midambles.

In another embodiment, an IoT device is provided. The IoT device includes a transceiver configured to receive a PRDCH from a reader. The PRDCH provides information related to a PDRCH transmission including at least a preamble format to prepend to the PDRCH between a short format and a long format, an interval for inserting one or more midambles in the PDRCH, an indicator for appending an additional midamble at an end of the PDRCH, and other D2R scheduling information. The IoT device further includes processing circuitry operably coupled with the transceiver, the processing circuitry configured to determine, based on reception of the PRDCH, a transmission of the PDRCH to the reader including the preamble format, whether to insert the one or more midambles, and whether to append the additional midamble. The transceiver is further configured to transmit, based on the determination, the PDRCH with a preamble and the one or more midambles.

In yet another embodiment, a reader is provided. The reader includes a processor and a transceiver operably coupled with the processor. The transceiver is configured to transmit a PRDCH to an IoT device. The PRDCH provides information related to a PDRCH transmission including at least a preamble format to prepend to the PDRCH between a short format and a long format, an interval for inserting one or more midambles in the PDRCH, an indicator for appending an additional midamble at an end of the PDRCH, and other D2R scheduling information. Transmission of the PRDCH indicates, for the PDRCH, the preamble format, whether to insert the one or more midambles, and whether to append the additional midamble. The transceiver is further configured to receive the PDRCH with a preamble and the one or more midambles.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure using orthogonal frequency division multiplexing (OFDM) according to embodiments of the present disclosure;

FIG. 6 illustrates an example of a receiver structure using OFDM according to embodiments of the present disclosure;

FIG. 7 illustrates an example encoding structure for a downlink control information (DCI) format according to embodiments of the present disclosure;

FIG. 8 illustrates an example decoding structure for a downlink control information (DCI) format according to embodiments of the present disclosure;

FIG. 9 illustrates an example type-1 backscatter structure for IoT devices according to embodiments of the present disclosure;

FIG. 10 illustrates an example impedance matching circuit according to embodiments of the present disclosure;

FIG. 11 illustrates an example type-2a backscatter structure for IoT devices according to embodiments of the present disclosure;

FIG. 12 illustrates an example type-2a backscatter structure for IoT devices according to embodiments of the present disclosure;

FIG. 13 illustrates an example type-2a backscatter structure for IoT devices according to embodiments of the present disclosure;

FIG. 14 illustrates an example type-2b active structure for IoT devices according to embodiments of the present disclosure;

FIG. 15 illustrates an example type-2b active structure for IoT devices according to embodiments of the present disclosure;

FIG. 16 illustrates an example type-2b active structure for IoT devices according to embodiments of the present disclosure;

FIG. 17 illustrates an example system for device to reader (D2R)/reader to device (R2D) transmission involving an intermediate node according to embodiments of the present disclosure;

FIG. 18 illustrates an example signal structure for ambient IoT (A-IoT) systems according to embodiments of the present disclosure;

FIG. 19 illustrates an example signal structure for A-IoT systems with midamble according to embodiments of the present disclosure;

FIG. 20 illustrates a flowchart of an example A-IoT device procedure for receiving R2D preamble according to embodiments of the present disclosure;

FIG. 21 illustrates a flowchart of an example A-IoT device procedure for generating D2R preamble according to embodiments of the present disclosure;

FIG. 22 illustrates a flowchart of an example A-IoT device procedure for receiving R2D preamble according to embodiments of the present disclosure;

FIG. 23 illustrates a flowchart of an example A-IoT device procedure for generating D2R preamble according to embodiments of the present disclosure;

FIG. 24 illustrates examples of signal structures according to embodiments of the present disclosure;

FIG. 25 illustrates an example signal structure for A-IoT systems with channel estimation (CE) field according to embodiments of the present disclosure; and

FIG. 26 illustrates timelines of an example consecutive R2D-R2D reception/D2R-D2R transmission according to embodiments of the present disclosure.

### DETAILED DESCRIPTION

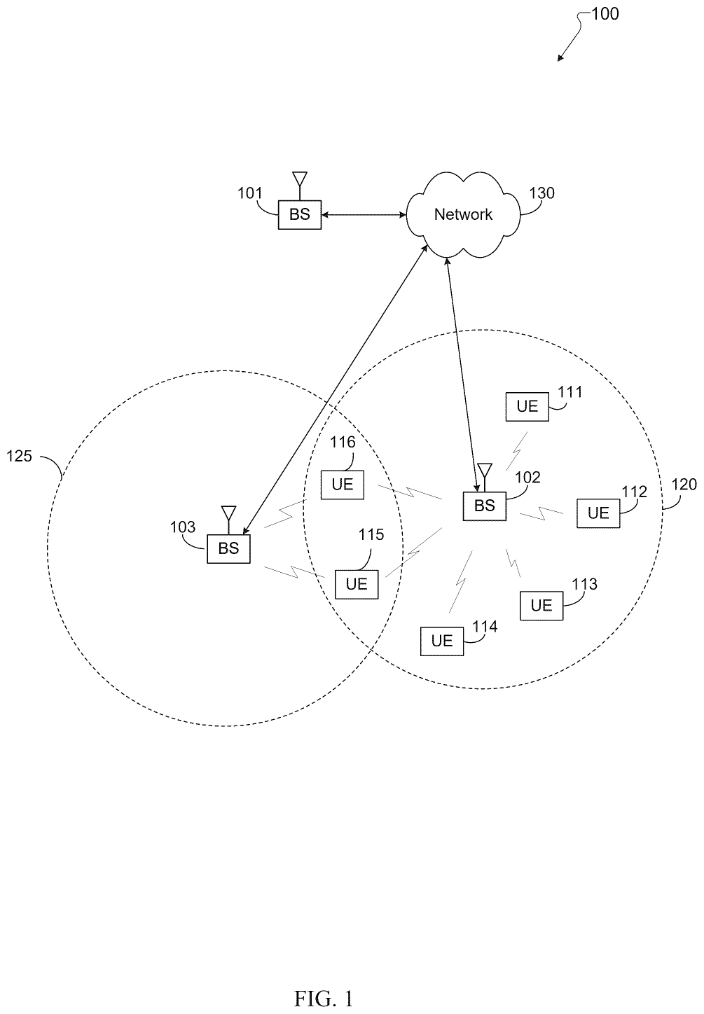

FIGS. 1-26, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [REF 1] 3GPP TS 38.211 v17.5.0, “NR; Physical channels and modulation;” [REF 2] 3GPP TS 38.212 v17.5.0, “NR; Multiplexing and channel coding;” [REF 3] 3GPP TS 38.213 v17.6.0, “NR; Physical layer procedures for control;” [REF 4] 3GPP TS 38.214 v17.6.0, “NR; Physical layer procedures for data;” [REF 5] 3GPP TS 38.331 v17.5.0, “NR; Radio Resource Control (RRC) protocol specification;” and [REF 6] 3GPP TS 38.321 v17.5.0, “NR; Medium Access Control (MAC) protocol specification.”

FIGS. 1-3 below describe various embodiments implemented in wireless communications systems and with the use of OFDM or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof to support a device-to-reader transmission with midamble. In certain embodiments, one or more of the gNBs 101-103 include circuitry, programing, or a combination thereof to support a device-to-reader transmission with midamble.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

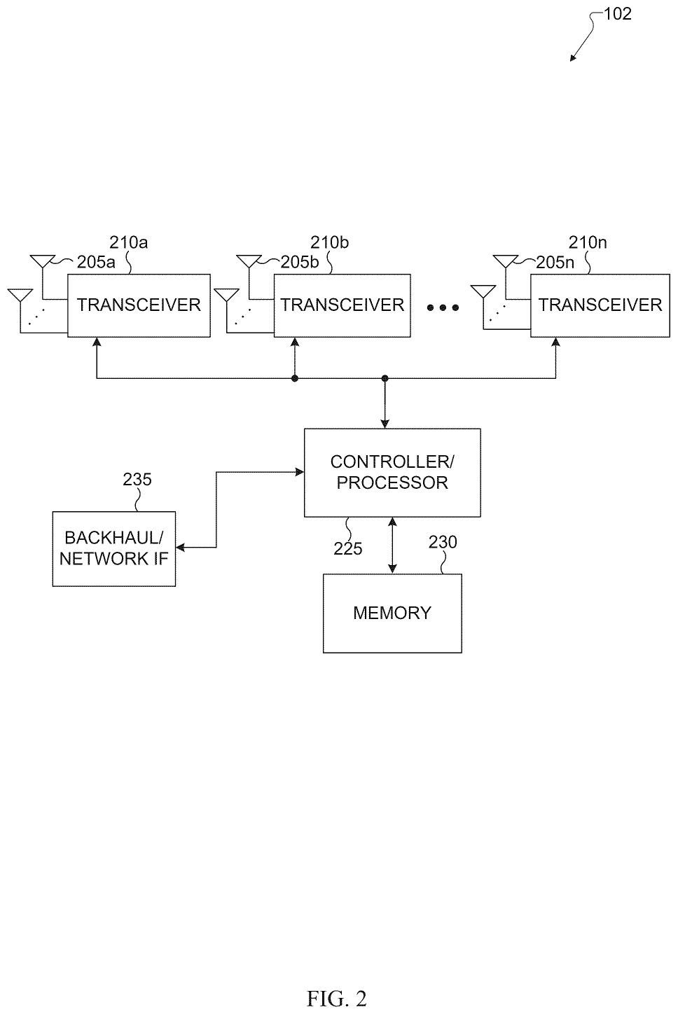

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as a device-to-reader transmission with midamble. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

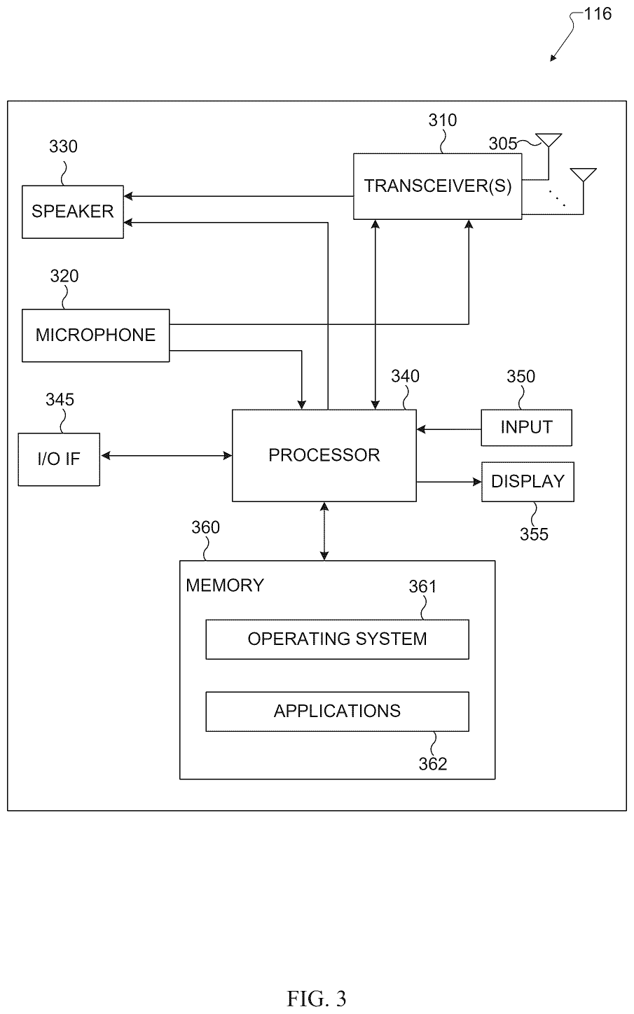

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to support a device-to-reader transmission with midamble as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include volatile memory such as a random-access memory (RAM), and another part of the memory 360 could include non-volatile memory a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

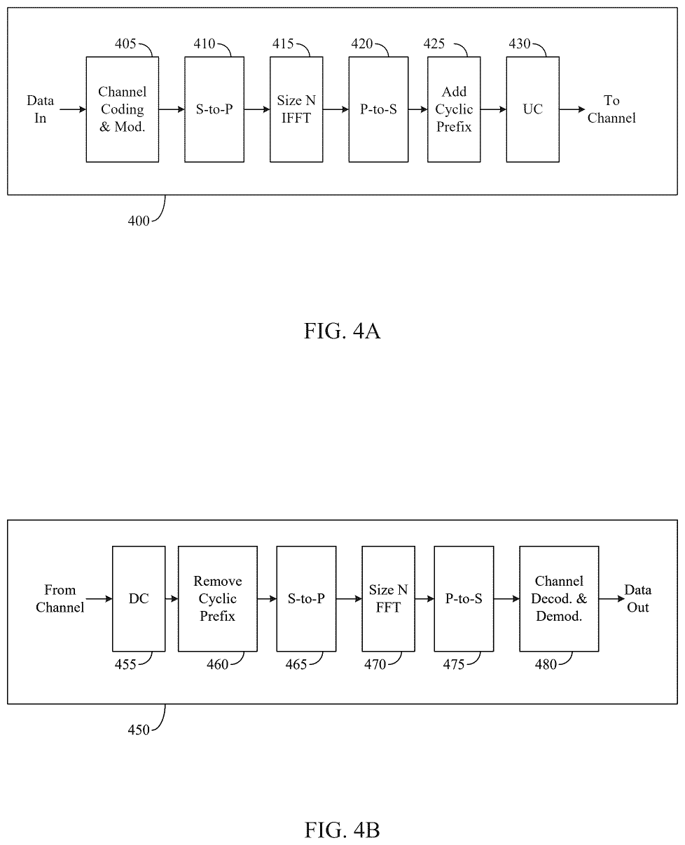

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured for a device-to-reader transmission with midamble as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

Internet of things (IoT) devices include ambient-power-enabled IoT (A-IoT) devices, which are ultra-low-complexity devices with very small form factor and low-cost design that operate without a common battery that can be manually replaced or recharged. Instead, A-IoT devices can be battery-less or with a small battery (such as a small capacitor) that operate based on energy harvesting from RF waveforms or other ambient energy sources. Regarding the limited size and complexity required by practical applications for battery-less devices with no energy storage capability or devices with limited energy storage that do not need to be replaced or recharged manually, the output power of energy harvester is typically from 1 μW to a few hundreds of μW.

In various embodiments throughout the disclosure, a UE (e.g., the UE 116) or a device may be referred to as an A-IoT device or an A-IoT UE based on energy harvesting with ultra-low complexity and power consumption and for low-end IoT applications. For example, the UE may have limited (or no) energy storage or battery capability (e.g., a capacitor), such as an energy storage unit for amplification of receptions at the UE or transmission by the UE, or for other UE operations, such as power-on, warm-up, memory, internal processing, and so on, or operating with backscattering communication.

An A-IoT device can be an IoT device that satisfies one or more of the following (or variations thereof):
powered by energy harvesting, being either battery-less or with limited energy storage capability (e.g., using a capacitor) and the energy is provided through the harvesting of radio waves (including RF waveforms), light (including solar light or indoor light), motion, pressure, heat, or any other power source that could be seen suitable;
with low complexity, small size and lower capabilities and lower power consumption than previously defined 3GPP IoT devices (e.g., NB-IoT/enhanced machine type communication (eMTC) devices);
maintenance free and can have long life span (e.g., more than 10 years).

An A-IoT may directly communicate with a base station/gNB (e.g., the BS 102) (e.g., operating as a reader), or may indirectly communicate with a BS/gNB through an intermediate/assisting node, such as a handheld device/UE (for example, a “reader” UE that scans the A-IoT devices), a relay, integrated access and backhaul (IAB) node, a repeater for example a network-controlled repeater (NCR), and so on. The communication can be mono-static wherein the transmitter node to the A-IoT device is same as the receiving node from the A-IoT device, or can be bi-static (or multi-static) wherein the transmitter nodes to the A-IoT device can be different from the receiving nodes from the A-IoT device.

In various embodiments, the A-IoT device operates with energy storage and power management capability. These devices are characterized by ultra-low power consumption, and they employ energy harvesting mechanisms such as solar, RF energy and kinetic energy and thus don't require battery replacement or swapping frequently. In various embodiments, an A-IoT device operates with energy harvesting (EH) or with limited (or no) energy storage/battery capability (such as a capacitor), such as an energy storage unit for amplification of receptions at the UE (e.g., the UE 116) or transmission by the UE, or for other UE operations, such as power-on, warm-up, memory, internal processing, and so on, or operating with backscattering communication.

In various embodiments, the A-IoT device operates with RF envelope detection for receiving amplitude shift keying (ASK), e.g., OOK, modulated signal. RF envelope detection is a key function that enables the Ambient IoT devices to filter and analyze RF signals. This technique is applied in the reception of modulated RF signals with a view of acquiring information from the signals and hence enable communication between devices with efficiency and with minimum power consumption. RF envelope detection is one of the most important techniques that are used in many of the low power consumption wireless communication protocols that are employed in Ambient IoT systems.

In various embodiments, the A-IoT device may operate with impedance matching. Impedance matching may be utilized in passive Ambient IoT devices backscattering externally provisioned carrier wave (CW) signal.

The disclosure relates to defining functionalities and procedures for A-IoT device operations related to a device-to-reader transmission with midamble. DL and UL are also referred to as reader-to-device (R2D) and device-to-reader (D2R), respectively, and vice versa.

FIG. 5 illustrates an example of a transmitter structure 500 using OFDM according to embodiments of the present disclosure. For example, transmitter structure 500 using OFDM can be implemented in gNB 102 of FIG. 1. This example is for illustration only and other embodiments can be used without departing from the scope of the present disclosure.

Information bits, such as DCI bits or data bits 510, are encoded by encoder 520, rate matched to assigned time/frequency resources by rate matcher 530, and modulated by modulator 540. Subsequently, modulated encoded symbols and demodulation reference signal (DM-RS) or channel state information reference signal (CSI-RS) 550 are mapped to REs 560, an inverse fast Fourier transform (IFFT) is performed by filter 570. A BW selector unit 565, a filter 580, a radio frequency (RF) amplifier 590, and transmitted signal 595 are also included.

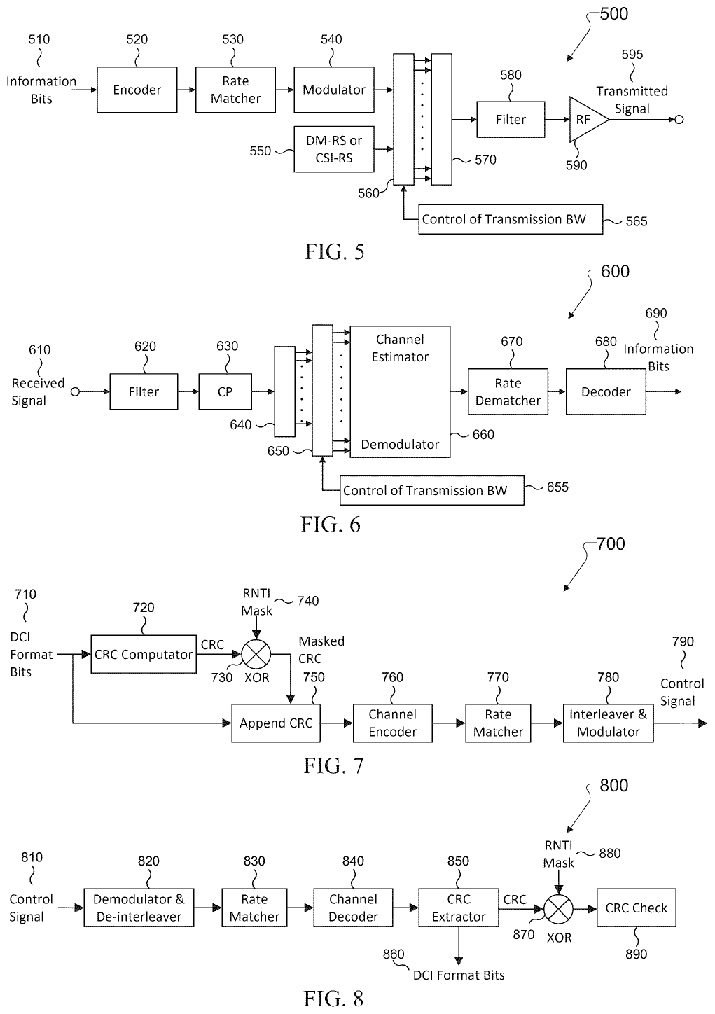

FIG. 6 illustrates an example of a receiver structure 600 using OFDM according to embodiments of the present disclosure. For example, receiver structure 600 using OFDM can be implemented by any of the UEs 111-116 of FIG. 1. This example is for illustration only and other embodiments can be used without departing from the scope of the present disclosure.

A received signal 610 is filtered by filter 620, a CP removal unit removes a CP 630, a filter 640 applies a fast Fourier transform (FFT), RE de-mapping unit 650 de-maps REs selected by BW selector unit 655, received symbols are demodulated by a channel estimator and a demodulator unit 660, a rate de-matcher 670 restores a rate matching, and a decoder 680 decodes the resulting bits to provide information bits 690.

With reference to FIG. 5, an example transmitter structure using OFDM according to this disclosure is shown.

With reference to FIG. 6, an example receiver structure using OFDM according to this disclosure is shown.

FIG. 7 illustrates an example encoding structure 700 for a downlink control information (DCI) format according to embodiments of the present disclosure. For example, encoding structure 700 can be implemented in gNB 102 of FIG. 1. This example is for illustration only and other embodiments can be used without departing from the scope of the present disclosure.

A gNB separately encodes and transmits each DCI format in a respective physical downlink control channel (PDCCH). When applicable, a radio network temporary identifier (RNTI) for a UE (e.g., the UE 116) that a DCI format is intended for masks a cyclic redundancy check (CRC) of the DCI format codeword in order to enable the UE to identify the DCI format. For example, the CRC can include 24 bits and the RNTI can include 16 bits or 24 bits. The CRC of (non-coded) DCI format bits 710 is determined using a CRC computation unit 720, and the CRC is masked using an exclusive OR (XOR) operation unit 730 between CRC bits and RNTI bits 740. The XOR operation is defined as XOR (0,0)=0, XOR (0,1)=1, XOR (1,0)=1, XOR (1,1)=0. The masked CRC bits are appended to DCI format information bits using a CRC append unit 750. An encoder 760 performs channel coding, such as polar coding, followed by rate matching to allocated resources by rate matcher 770. Interleaving and modulation units 780 apply interleaving and modulation, such as QPSK, and the output control signal 790 is transmitted.

FIG. 8 illustrates an example decoding structure 800 for a DCI format according to embodiments of the present disclosure. For example, decoding structure 800 for a DCI format can be implemented by any of the UEs 111-116 of FIG. 1. This example is for illustration only and other embodiments can be used without departing from the scope of the present disclosure.

A received control signal 810 is demodulated and de-interleaved by a demodulator and a de-interleaver 820. A rate matching applied at a gNB transmitter is restored by rate matcher 830, and resulting bits are decoded by decoder 840. After decoding, a CRC extractor 850 extracts CRC bits and provides DCI format information bits 860. The DCI format information bits are de-masked 870 by an XOR operation with a RNTI 880 (when applicable) and a CRC check is performed by unit 890. When the CRC check succeeds (check-sum is zero), the DCI format information bits are regarded to be valid. When the CRC check does not succeed, the DCI format information bits are regarded to be invalid.

With reference to FIG. 7, an example encoding process for a DCI format according to this disclosure is shown.

With reference to FIG. 8, an example decoding process for a DCI format for use with a UE according to this disclosure is shown.

It is envisaged that the number of connected devices will reach ˜500 billion by 2030, which is about ˜59 times larger than the expected world population (˜8.5 billion) by that time. Mobile devices will take various form-factors, such as augmented reality (AR) glasses, virtual reality (VR) headsets, hologram devices, while a large portion of the devices will be Internet-of-Things (IoT) devices for improving productivity efficiency and increasing comforts of life. As the number of IoT devices grows exponentially, those IoT devices will become dominant in the next generation wireless communication systems such as fifth generation (5G) advanced, sixth generation (6G) systems, and so on.

With the explosive number of IoT devices, it may be challenging to power the IoT devices by battery that needs to be replaced or recharged manually, which leads to high maintenance cost. The automation and digitalization of various industries demand new IoT technologies of supporting batteryless devices with no energy storage capability or devices with energy storage that does not need to be replaced or recharged manually. Such types of devices are collectively termed as ambient IoT (A-IT) in this disclosure, which is powered by various renewable energy sources such as radio waves, light, motion, or heat, etc. Use cases of A-IoT devices include asset inventory/tracking and remote environmental monitoring. The following list provides example use cases of A-IoT devices:
Indoor inventory
Automated warehousing
Medical instruments inventory management and positioning
Non-Public Network for logistics
Automobile manufacturing
Airport terminal/shipping port
Smart laundry
Automated supply chain distribution
Fresh food supply chain
End-to-end logistics
Flower auction
Electronic shelf label
Indoor sensor
Smart homes
Base station machine room environmental supervision
Smart laundry
Smart agriculture
Smart pig farm
Cow stable
Indoor positioning
Finding Remote Lost Item
Location service
Ranging in a home
Personal belongings finding
Positioning in shopping center
Museum Guide
Indoor command
Online modification of medical instruments status
Device activation and deactivation
Elderly Health Care
Device Permanent Deactivation
Electronic shelf label
Outdoor inventory
Medical instruments inventory management and positioning
Non-public network for logistics
Airport terminal/shipping port
Automated supply chain distribution
Outdoor sensor
Smart grids
Forest Fire Monitoring
Dairy farming
Smart manhole cover safety monitoring
Smart bridge health monitoring
Outdoor positioning
Finding remote lost item
Location service
Personal belongings finding
Outdoor command
Online modification of medical instruments status
Device activation and deactivation
Elderly Health Care
Controller in smart agriculture

Taking into account the limited size and low complexity required by practical applications of A-IoT devices, the output power of energy harvesting from ambient power sources is typically from 1 μW to a few hundreds of μW, which is orders of magnitude lower than normal user equipment (UE) having peak power consumption higher than 10 mW. This requires a new wireless access technology for A-IoT devices, which cannot be fulfilled by existing cellular systems including low-power IoT technologies such as NB-IoT and eMTC.

In the following, an italicized name for a parameter implies that the parameter is provided by higher layers.

DL (e.g., physical reader to device (R2D) channel (PRDCH)) transmissions or UL (e.g., PDRCH) transmissions can be based on an OFDM waveform including a variant using DFT precoding that is known as DFT-spread-OFDM that is typically applicable to UL transmissions.

In the following, subframe (SF) refers to a transmission time unit for the LTE RAT and slot refers to a transmission time unit for an NR RAT. For example, the slot duration can be a sub-multiple of the SF duration. NR can use a different DL or UL slot structure than an LTE SF structure. Differences can include a structure for transmitting physical downlink control channels (PDCCHs), locations and structure of demodulation reference signals (DM-RS), transmission duration, and so on. Further, eNB refers to a base station serving UEs operating with LTE RAT and gNB refers to a base station serving UEs operating with NR RAT. Exemplary embodiments provide a same numerology, that includes a sub-carrier spacing (SCS) configuration and a cyclic prefix (CP) length for an OFDM symbol, for transmission with LTE RAT and with NR RAT. In such case, OFDM symbols for the LTE RAT as same as for the NR RAT, a subframe is same as a slot and, for brevity, the term slot is subsequently used in the remaining of the disclosure.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. A sub-carrier spacing (SCS) can be determined by a SCS configuration μ as 2^{μ}·15 kHz. A unit of one sub-carrier over one symbol is referred to as resource element (RE). A unit of one RB over one symbol is referred to as physical RB (PRB).

DL signaling include physical downlink shared channels (PDSCHs) conveying information content, PDCCHs conveying DL control information (DCI), and reference signals (RS). A PDCCH can be transmitted over a variable number of slot symbols including one slot symbol and over a number of control channel elements (CCEs) from a predetermined set of numbers of CCEs referred to as CCE aggregation level within a control resource set (CORESET) as described in v17.6.0 of [REF 1] and v17.6.0 of [REF 3].

DCI can serve several purposes. A DCI format includes a number of fields, or information elements (IEs), and is typically used for scheduling a PDSCH (DL DCI format) or a PUSCH (UL DCI format) transmission. A DCI format includes cyclic redundancy check (CRC) bits in order for a UE (e.g., the UE 116) to confirm a correct detection. A DCI format type is identified by a radio network temporary identifier (RNTI) that scrambles the CRC bits. For a DCI format scheduling a physical downlink shared channel (PDSCH) or a PUSCH for a single UE with RRC connection to a gNB (e.g., the BS 102), the RNTI is a cell RNTI (C-RNTI) or another RNTI type such as a modulation and coding scheme-cell RNTI (MCS-C-RNTI). For a DCI format scheduling a PDSCH conveying system information (SI) to a group of UEs, the RNTI is a system information RNTI (SI-RNTI). For a DCI format scheduling a PDSCH providing a response to a random access (RA) from a group of UEs, the RNTI is a random access (RA-RNTI). For a DCI format scheduling a PDSCH providing contention resolution in Msg4 of a RA process, the RNTI is a temporary C-RNTI (TC-RNTI). For a DCI format scheduling a PDSCH paging a group of UEs, the RNTI is a paging RNTI (P-RNTI). For a DCI format providing transmission power control (TPC) commands to a group of UEs, the RNTI is a transmit power control radio network temporary identifier (TPC-RNTI), and so on. Each RNTI type is configured to a UE through higher layer signaling. A UE typically decodes at multiple candidate locations for PDCCH receptions as determined by an associated search space set.

For each DL bandwidth part (BWP) indicated to a UE in a serving cell, the UE can be provided by higher layer signaling with P≤3 control resource sets (CORESETs). For each CORESET, the UE is provided a CORESET index p, 0≤p<12, a DM-RS scrambling sequence initialization value, a precoder granularity for a number of resource element groups (REGs) in the frequency domain where the UE can expect use of a same DM-RS precoder, a number of consecutive symbols for the CORESET, a set of resource blocks (RBs) for the CORESET, control channel element to resource element group (CCE-to-REG) mapping parameters, an antenna port quasi co-location, from a set of antenna port quasi co-locations, indicating quasi co-location information of the DM-RS antenna port for PDCCH reception in a respective CORESET, and an indication for a presence or absence of a transmission configuration indication (TCI) field for DCI format 1_1 transmitted by a PDCCH in CORESET p.

For each DL BWP configured to a UE in a serving cell, the UE is provided by higher layers with S≤10 search space sets. For each search space set from the S search space sets, the UE is provided a search space set index s, 0≤s<40, an association between the search space set s and a CORESET p, a PDCCH monitoring periodicity of kₛ slots and a PDCCH monitoring offset of oₛ slots, a PDCCH monitoring pattern within a slot, indicating first symbol(s) of the CORESET within a slot for PDCCH monitoring, a duration of Tₛ<kₛ slots indicating a number of slots that the search space set s exists, a number of PDCCH candidates MS per CCE aggregation level L, and an indication that search space set s is either a common search space (CSS) set or a UE-specific search space (USS) set. When search space set s is a CSS set, the UE monitors PDCCH for detection of DCI format 2_x, where x ranges from 0 to 7 as described in v17.6.0 of [REF2] or for DCI formats associated with scheduling broadcast/multicast PDSCH receptions, and for DCI format 0_0 and DCI format 1_0.

A UE determines a PDCCH monitoring occasion on an active DL BWP from the PDCCH monitoring periodicity, the PDCCH monitoring offset, and the PDCCH monitoring pattern within a slot. For search space set s, the UE determines that a PDCCH monitoring occasion(s) exists in a slot with number

$${n}_{s , f}^{μ}$$

in a frame with number n_{f} if

$$( {n}_{f} \cdot {N}_{slot}^{frame , μ} + {n}_{s , f}^{μ} - {o}_{s} ) mod {k}_{s} = 0.$$

The UE monitors PDCCH candidates for search space set s for Tₛ consecutive slots, starting from slot

$${n}_{s , f}^{μ} ,$$

and does not monitor PDCCH candidates for search space set s for the next kₛ−Tₛ consecutive slots. The UE determines CCEs for monitoring PDCCH according to a search space set based on a search space equation as described in [REF3].

A UE expects to monitor PDCCH candidates for up to 4 sizes of DCI formats that include up to 3 sizes of DCI formats with CRC scrambled by C-RNTI per serving cell. The UE counts a number of sizes for DCI formats per serving/scheduled cell based on a number of PDCCH candidates in respective search space sets for the corresponding active DL BWP. In the following, for brevity, that constraint for the number of DCI format sizes will be referred to as DCI size limit. When the DCI size limit would be exceeded for a UE based on a configuration of DCI formats that the UE monitors PDCCH, the UE aligns the size of some DCI formats, as described in v17.6.0 of [REF2], so that the DCI size limit would not be exceeded.

For each scheduled cell, the UE is not required to monitor on the active DL BWP with SCS configuration μ of the scheduling cell more than

$$min ( {M}_{PDCCH}^{max , slot , μ} , {M}_{PDCCH}^{total , slot , μ} )$$

PDCCH candidates or more than

$$min ( {C}_{PDCCH}^{max , slot , μ} , {C}_{PDCCH}^{total , slot , μ} )$$

non-overlapped CCEs per slot, wherein

$${M}_{PDCCH}^{max , slot , μ} and {C}_{PDCCH}^{max , slot , μ}$$

are respectively a maximum number of PDCCH candidates and non-overlapping CCEs for a scheduled cell and

$${M}_{PDCCH}^{total , slot , μ} and {C}_{PDCCH}^{total , slot , μ}$$

are respectively a total number of PDCCH candidates and non-overlapping CCEs for a scheduling cell, as described in [REF3].

A UE does not expect to be configured CSS sets, other than CSS sets for multicast PDSCH scheduling, that result to corresponding total, or per scheduled cell, numbers of monitored PDCCH candidates and non-overlapped CCEs per slot on the primary cell that exceed the corresponding maximum numbers per slot. For USS sets or for CSS sets associated with multicast PDSCH scheduling, when a number of PDCCH candidates or non-overlapping CCEs in a slot would exceed the limits/maximum per slot for scheduling on the primary cell mentioned herein, the UE selects the USS sets or the CSS sets to monitor corresponding PDCCH in an ascending order of a corresponding search space set index until and an index of a search space set for which PDCCH monitoring would result to exceeding the maximum number of PDCCH candidates or non-overlapping CCEs per slot for scheduling on the PCell as described in [REF3].

For same cell scheduling or for cross-carrier scheduling where a scheduling cell and scheduled cells have DL BWPs with same SCS configuration u, a UE does not expect a number of PDCCH candidates, and a number of corresponding non-overlapped CCEs per slot on a secondary cell to be larger than the corresponding numbers that the UE is capable of monitoring on the secondary cell per slot. For cross-carrier scheduling, the number of PDCCH candidates for monitoring and the number of non-overlapped CCEs per slot are separately counted for each scheduled cell.

A UE can be configured for operation with carrier aggregation (CA) for PDSCH receptions over multiple cells (DL CA) or for PUSCH transmissions over multiple cells (UL CA). The UE can also be configured multiple transmission-reception points (TRPs) per cell via indication (or absence of indication) of a coresetPoolIndex for CORESETs where the UE receives PDCCH/PDSCH from a corresponding TRP as described in v17.6.0 of [REF3] and [REF4].

MIMO technologies have a key role in boosting system throughput both in NR and LTE and such a role will continue and further expand in the future generations of wireless technologies. For MIMO operation, an antenna port is defined such that a channel over which a symbol on the antenna port is conveyed can be inferred from the channel over which another symbol on the same antenna port is conveyed. There is not necessarily a one to one correspondence between an antenna port and an antenna element, and a plurality of antenna elements can be mapped onto one antenna port.

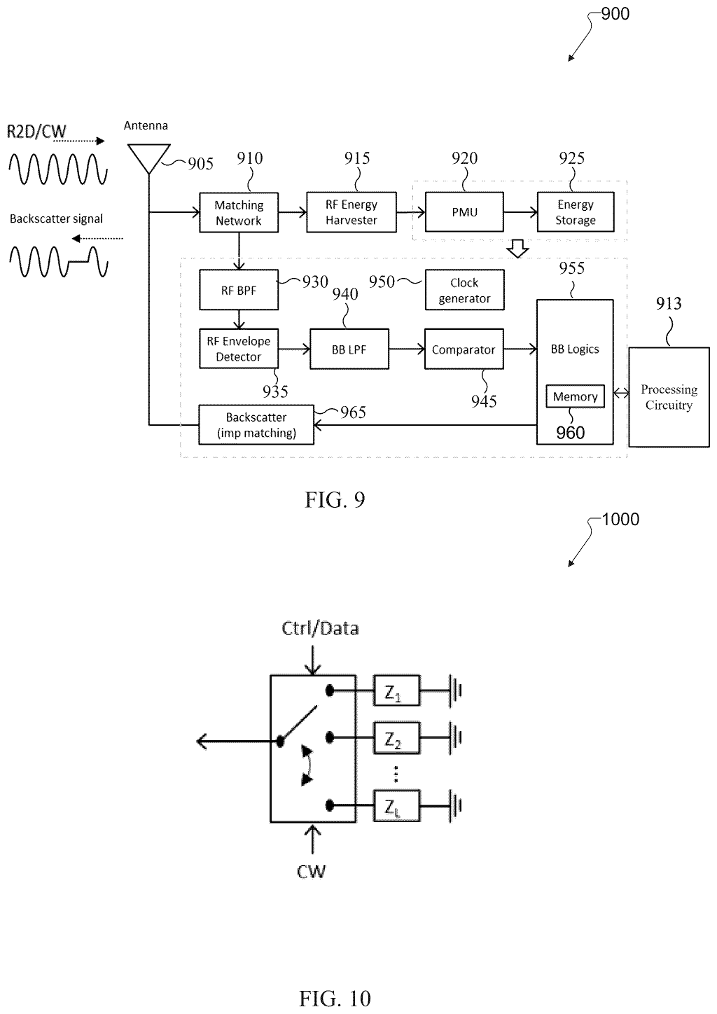

FIG. 9 illustrates a diagram of an example type-1 backscatter structure 900 for IoT devices according to embodiments of the present disclosure. For example, type-1 backscatter structure 900 can be implemented by any of the UEs 111-116 of FIG. 1, or may be devices with fewer components and functionality than a UE. This example is for illustration only and other embodiments can be used without departing from the scope of the present disclosure.

As shown in FIG. 9, the type-1 backscatter structure 900 for IoT devices includes an antenna 905, a matching network 910, a RF energy harvester 915, a power measurement unit (PMU) 920, an energy storage 925, a RF bandpass filter (BPF) 930, a RF envelope detector 935, a baseband (BB) lowpass filter (LPF) 940, a comparator 945, a clock generator 950, a BB logistics 955, a memory 960, backscatter (imp matching) 965, and processing circuitry 913.

In various embodiments, the processing circuitry 913, which may be a full-powered processor, such as included in UE 116, a lower-power microprocessor or microcontroller, an application specific integrated circuit (ASIC), or logic circuitry. The processing circuitry 913 can control the overall operation of the IoT device including determination of reception and/or transmission timing. The processing circuitry 913 may be powered via energy storage 925. The signal receiving and transmitting processing circuitry included in the IoT devices, such as RF BPF 930, a RF envelope detector 935, a BB LPF 940, a comparator 945, a clock generator 950, a BB logistics 955, a memory 960, and a backscatter (impedance matching) 965, may be referred to as a transceiver, which may use separate antennas for reception and transmission, respectively, or may use a common antenna, such as antenna 905 for transmission and reception. One or more implementations described herein further include other implementation variations such as separate Tx-Rx antennas vs common Tx-Rx antenna, use of a sensor, etc. The implementations should be understood as an example and not as a restriction.

FIG. 10 illustrates a diagram of an example impedance matching circuit according to embodiments of the present disclosure. For example, impedance matching circuit 1000 can be implemented in any of the IoT device described herein. This example is for illustration only and other embodiments can be used without departing from the scope of the present disclosure.

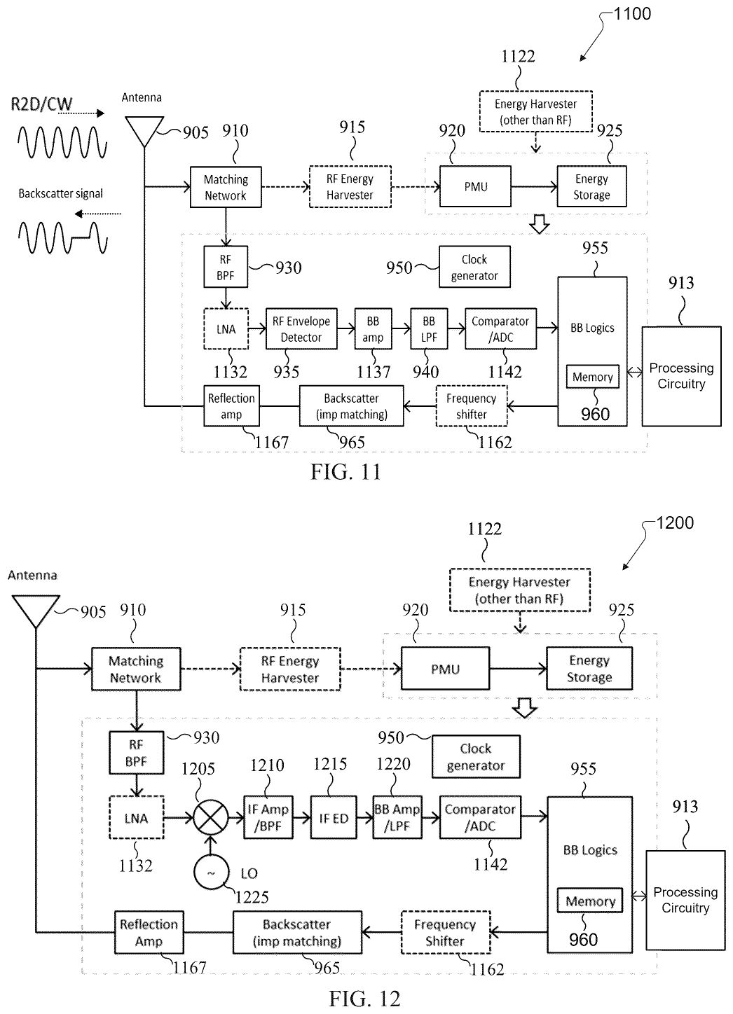

FIG. 11 illustrates a diagram of an example type-2a backscatter structure 1100 for IoT devices according to embodiments of the present disclosure. For example, backscatter structure 1100 can be implemented by any of the UEs 111-116 of FIG. 1, such as the UE 111, or may be devices with fewer components and functionality than a UE. This example is for illustration only and other embodiments can be used without departing from the scope of the present disclosure.

As shown in FIG. 11, the type-2a backscatter structure 1100 includes an antenna 905, a matching network 910, a RF energy harvester 915, a PMU 920, an energy storage 925, an energy harvester (other than RF) 1122, a RF BPF 930, a low noise amplifier (LNA) 1132, a RF envelope detector 935, a BB amp 1137, a BB LPF 940, a comparator/ADC 1142, a clock generator 950, a BB logistics 955, a memory 960, a frequency shifter 1162, backscatter (imp matching) 965, a reflection amp 1167, and processing circuitry 913.

FIG. 12 illustrates a diagram of an example type-2a backscatter structure 1200 for IoT devices according to embodiments of the present disclosure. For example, backscatter structure 1200 can be implemented by any of the UEs 111-116 of FIG. 1, such as the UE 112, or may be devices with fewer components and functionality than a UE. This example is for illustration only and other embodiments can be used without departing from the scope of the present disclosure.

As shown in FIG. 12, the type-2a backscatter structure 1200 includes an antenna 905, a matching network 910, a RF energy harvester 915, a PMU 920, an energy storage 925, an energy harvester (other than RF) 1122, a RF BPF 930, a LNA 1132, a mixer 1205, a LO 1225, an IF amp/BPF 1210, an IF ED 1215, a BB Amp/LPF 1220, a comparator/ADC 1142, a clock generator 950, a BB logistics 955, a memory 960, a frequency shifter 1162, a backscatter (impedance Matching) 965, reflection amp 1167, and processing circuitry 913.

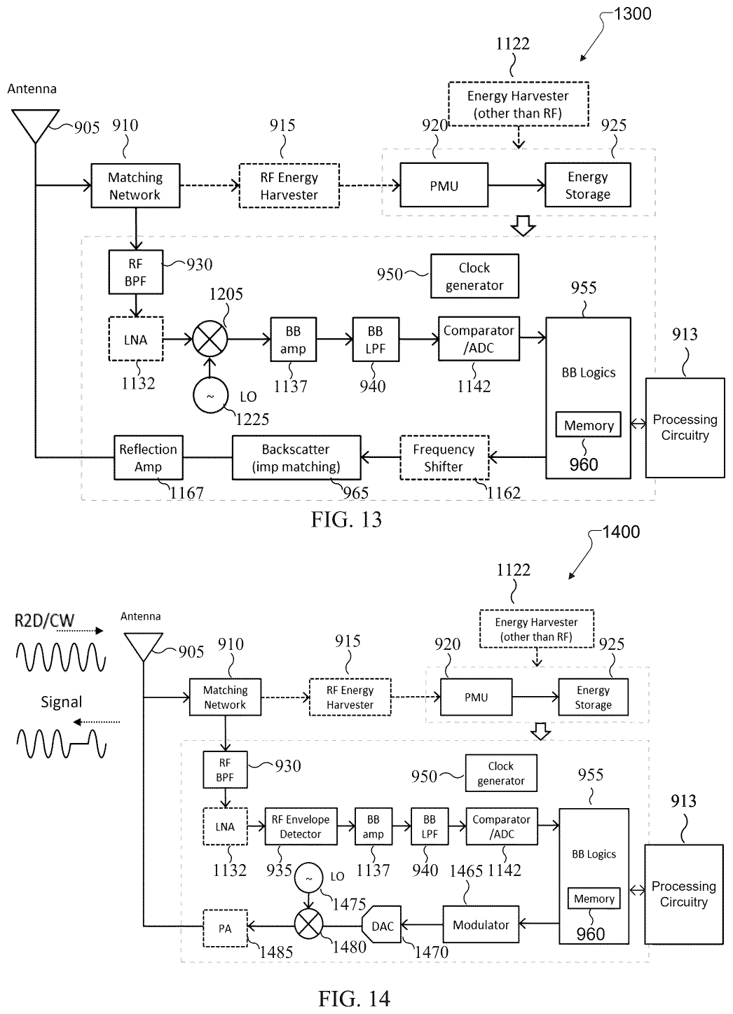

FIG. 13 illustrates a diagram of an example type-2a backscatter structure 1300 for IoT devices according to embodiments of the present disclosure. For example, structure 1300 can be implemented by any of the UEs 111-116 of FIG. 1, such as the UE 113, or may be devices with fewer components and functionality than a UE. This example is for illustration only and other embodiments can be used without departing from the scope of the present disclosure.

As shown in FIG. 13, the type-2a backscatter structure 1300 includes an antenna 905, a matching network 910, a RF energy harvester 915, a PMU 920, an energy storage 925, an energy harvester (other than RF) 1122, a RF BPF 930, a LNA 1132, a mixer 1205, an LO 1225, a BB amplifier 1137, a BB LPF 940, a comparator/ADC 1142, a clock generator 950, a BB logistics 955, a memory 960, a frequency shifter 1162, a backscatter (impedance matching) 965, a reflection amp 1167, and processing circuitry 913.

FIG. 14 illustrates a diagram of an example type-2b active structure 1400 for IoT devices according to embodiments of the present disclosure. For example, active structure 1400 can be implemented by any of the UEs 111-116 of FIG. 1, such as the UE 114, or may be devices with fewer components and functionality than a UE. This example is for illustration only and other embodiments can be used without departing from the scope of the present disclosure.

As shown in FIG. 14, the type-2b active structure 1400 includes an antenna 905, a matching network 910, a RF energy harvester 915, a PMU 920, an energy storage 925, an energy harvester (other than RF) 1122, a RF BPF 930, a LNA 1132, a RF envelope detector 935, a BB amp 1137, a BB LPF 940, a comparator/ADC 1142, a clock generator 950, a BB logistics 955, a memory 960, a modulator 1465, a digital to analog converter (DAC) 1470, a LO 1475, a mixer 1480, a PA 1485, and processing circuitry 913.

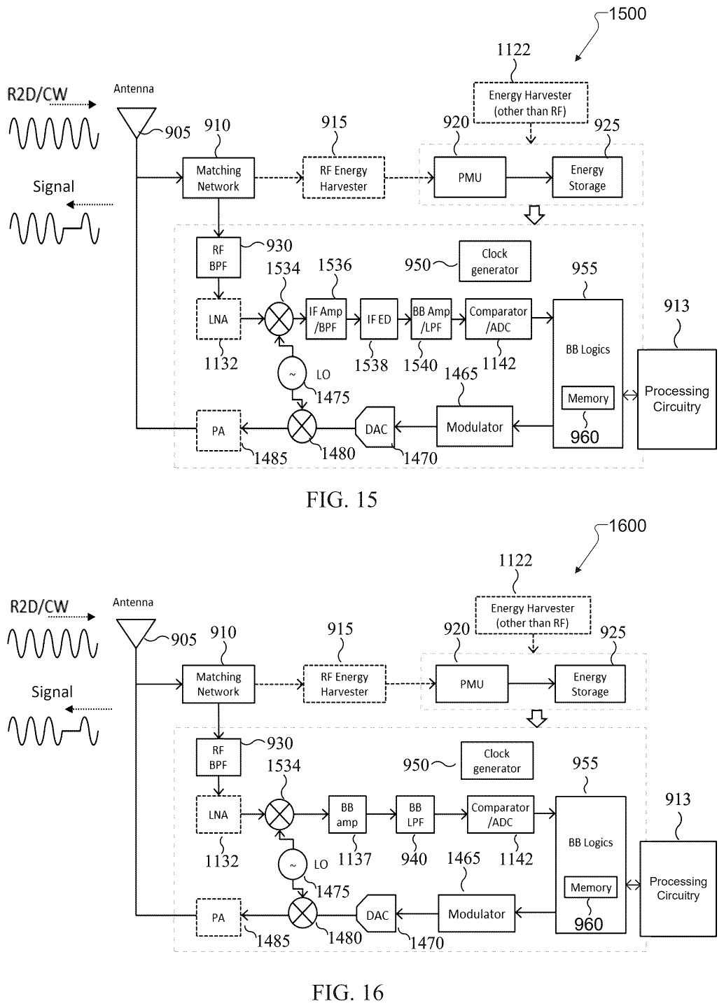

FIG. 15 illustrates a diagram of an example type-2b active structure 1500 for IoT devices according to embodiments of the present disclosure. For example, active structure 1500 can be implemented by any of the UEs 111-116 of FIG. 1, such as the UE 115, or may be devices with fewer components and functionality than a UE. This example is for illustration only and other embodiments can be used without departing from the scope of the present disclosure.

As shown in FIG. 15, the structure 1500 includes an antenna 905, a matching network 910, a RF energy harvester 915, a PMU 920, an energy storage 925, an energy harvester (other than RF) 1122, a RF BPF 930, a LNA 1132, a mixer 1534, an IF amp/BPF 1536, an IF ED 1538, a BB amp/LPF 1540, a comparator/ADC 1142, a clock generator 950, a BB logistics 955, a memory 960, a modulator 1465, a DAC 1470, a LO 1475, a mixer 1480, a PA 1485, and processing circuitry 913.

FIG. 16 illustrates a diagram of an example type-2b active structure 1600 for IoT devices according to embodiments of the present disclosure. For example, active structure 1600 can be implemented by any of the UEs 111-116 of FIG. 1, such as the UE 116, or may be devices with fewer components and functionality than a UE. This example is for illustration only and other embodiments can be used without departing from the scope of the present disclosure.

As shown in FIG. 16, the structure 1600 includes an antenna 905, a matching network 910, a RF energy harvester 915, a PMU 920, an energy storage 925, an energy harvester (other than RF) 1122, a RF BPF 930, a LNA 1132, a mixer 1534, a BB amp 1137, a BB LPF 940, a comparator/ADC 1142, a clock generator 950, a BB logistics 955, a memory 960, a modulator 1465, a DAC 1470, a LO 1475, a mixer 1480, a PA 1285, and processing circuitry 913.

Several different types of A-IoT devices can be regarded as following.
Device 1: ˜1 μW peak power consumption, has energy storage, initial sampling frequency offset (SFO) up to 10× ppm, neither R2D nor D2R amplification in the device. The device's D2R transmission is backscattered on a carrier wave provided externally.
Device 2a: ≤a few hundred μW peak power consumption, has energy storage, initial sampling frequency offset (SFO) up to 10× ppm, both R2D and/or D2R amplification in the device. The device's D2R transmission is backscattered on a carrier wave provided externally.
Device 2b: ≤a few hundred μW peak power consumption, has energy storage, initial sampling frequency offset (SFO) up to 10× ppm, both R2D and/or D2R amplification in the device. The device's D2R transmission is generated internally by the device.

The devices may operate in frequency division duplexing (FDD) spectrum or time division duplexing (TDD) spectrum, which may be licensed or unlicensed.

In the following, reference architectures for the device types herein are provided, which should be understood as an example and not as a restriction.

With reference to FIG. 9, an example Type-1 backscatter device structure according to the disclosure is shown.

The RF energy harvester 915 converts RF signal to DC power and supplies the device. Either a R2D signal or an externally provisioned CW signal for backscattering can be utilized for RF energy harvesting. The CW is externally provided from a gNB or a dedicated source. The source of CW signal, e.g., either a gNB or a dedicated node, may or may not be agnostic to A-IoT devices. The harvested energy, e.g., using a rectifier, can be stored using a capacitor, super-capacitor, or, generally speaking, an energy storage. Antenna could be either shared or separate for RF energy harvester and receiver/transmitter. Matching network 910 is to match impedance between antenna and other components. Clock generator 950 provides required clock signal(s).

The PMU 920 manages storing energy to energy storage from energy harvester and supplying power to active component blocks which needs power supply. The PMU 920 can also transition the device operation state between at least ON state, the OFF state, and the power saving (PS) state. The PMU 920 includes or is implemented by power management circuitry. In some embodiments, the PMU 920 may be implemented by program code (e.g., software or firmware) executed by one or more processors such as the processing circuitry 913, such that, in some embodiments, the power management circuitry of the PMU 920 is the same as or includes at least some of the processing circuitry 913. In other embodiments, the power management circuitry of the PMU 920 may be a separate processor, controller, or circuit, such as a lower-power microprocessor or microcontroller, an ASIC, or logic circuitry that is programmed to implement the functions of the PMU 920 or configured to implement the functions of the PMU 920 in logic.

The R2D signal is demodulated using a low complexity envelope detector and comparator, whose output is provided as an input to the baseband circuit. Given the low-power and low-complexity requirements of the Type-1 backscatter device, an RF envelope detection can be a viable solution for a receiver architecture, compared to a heterodyne architecture with IF envelope detection or a homodyne architecture with baseband envelope detection, which require LO and frequency mixer for frequency down-conversion. The input RF signal passes through an RF band-pass filter (BPF) 930 for an adjacent channel interference suppression, and then the filtered RF signal is directly converted into a baseband using an RF envelope detector 935, followed by a baseband low-pass filter (LPF) 940 for filtering out harmonics and high frequency components, and an n-bit comparator, where n can be 1, 2, 4, 8, . . . . The use of filters, e.g., BPF 930 only, LPF 940 only, or both, can be an implementation choice.

For the D2R backscatter transmission, any of the following can be used:
Case 1) CW is provisioned at DL spectrum and backscattered, i.e., CW @ DL spectrum, D2R backscattering @ DL spectrum.
Case 2) CW is provisioned at UL spectrum and backscattered, i.e., CW @ UL spectrum, D2R backscattering @ UL spectrum.
Case 3) CW is provisioned at DL spectrum, frequency shifted to UL spectrum, and then backscattered, i.e., CW @ DL spectrum, D2R backscattering @ UL spectrum.

In one example, Case 1) or Case 2) is evaluated for device 1, i.e., CW and D2R backscattering on the same frequency and, therefore, a frequency shifter (FS) is not required.

With reference to FIG. 10, an example impedance matching circuit for backscatter device D2R modulation according to the disclosure is shown.

The following are simple examples of impedance matching operations:
Open circuit: Full reflection of the received CW signal in the same phase. This can be used for OOK modulation with matching circuit.
Short circuit: Full reflection of the received CW signal in the reversed phase. This can be used for phase-shift keying (PSK) modulation.
Matching circuit: No reflection as the impedance is matched to a load, i.e., absorption. This can be utilized for energy harvesting, Rx mode, or modulation with other matching states.
Multi-level matching circuit: As illustrated in FIG. 10. Multi-level impedance matching to Z₁, Z₂, . . . , Z_{L} for log₂(L) bits per symbol ASK modulation.

Depending on the matched load impedance, the matching circuit can backscatter the incoming CW signal with different reflection coefficients in both amplitude and phase. In general, amplitude shift keying (ASK)/phase shift keying (PSK)/frequency shift keying (FSK) may be supported using an impedance matching circuit. As a simplest modulation scheme, OOK may be evaluated. The device may indicate its modulation capability or impedance matching capability to the network (e.g., the network 130), or certain requirement may be predefined in the specification of system operation.

With reference to FIG. 11, an example device 2a backscatter architecture based on RF envelope detection according to the disclosure is shown.

The device 2a may share similar structure at large with device 1 as the D2R transmission is still based on backscattering of an externally provided CW, while the device 2a may differ from device 1 from the following aspects.

The device 2a has ≤a few hundred μW peak power consumption and both R2D and/or D2R amplification in the device. In this case, alternative to the RF energy harvesting from a R2D signal or an externally provided CW signal, other renewable energy sources, e.g., solar, thermal, kinetic, etc., may be provided for energy harvesting. The presence of a certain energy harvesting capability from a certain renewable energy source may be expected for system design point of view. The use of energy harvesters, e.g., RF energy harvester 915 only, other energy harvester only, or both, can be an implementation choice.

The device 2a may be equipped with both R2D and/or D2R amplification in the device. Given the power consumption requirement, i.e., ≤a few hundred μW, the R2D/D2R amplification for device 2a may be based on an architecture that is different from the typical power amplifier (PA) and low noise amplifier (LNA). In some example low-power/complexity architectures for forward amplifier for reader-to-device (R2D) reception and reflection amplifier for device-to-reader (D2R) transmission, a single bipolar transistor terminated with microstrips may be used. The receiver amplification can be either RF amplification prior to the envelope detector, baseband amplification after the envelope detector, or both, which is an implementation choice. In one example, a reflection amplifier is used for both R2D reception and D2R transmission, and LNA may or may not exist. In another example, a reflection amplifier is used for D2R transmission only and LNA is used for R2D reception amplification.

In one example, a reflection amplifier can be used only for backscattering, i.e., one-way amplification. In another example, a reflection amplifier can be used for both backscattering and receiving, i.e., two-way amplification. For a reflection amplifier, it can be expected that 10˜25 dB gain is achievable, at a power consumption of a few tens to hundreds micro-Watts. It is noted that an exact power consumption value will be highly dependent on implementations. On the other hand, a stability of an amplifier is a function of an input impedance and operating frequency. Since A-IoT devices are expected to be deployed for a certain operating frequency and not expected to adapt to another frequency after deployment, the implementation can ensure a stable operation of the amplifier for the target frequency.

One additional difference of device 2a compared to device 1 may be a use of a FS. With a few hundred μW peak power consumption, some low-power LO architectures with a frequency mixer can be taken into account for Case 3). With FS, it can be expected that the CW is provided in a frequency different than the UL carrier frequency. Because the A-IoT devices are targeting for low complexity and low power consumption, the following options can be evaluated as an example method for frequency shift:
Ultra-low power local oscillator (LO), whose output frequency is multiplied in one or more stages using a frequency multiplier to obtain a desired amount of frequency shift.
Calibrated RC (resistor-capacitor) oscillator, which uses CW frequency as an input to the RC oscillator with phase locked loop (PLL) circuitry.
CW signal provided at the UL carrier frequency; In this case, no frequency shifter is needed.
Use of harmonic frequencies of CW signal or intermodulation frequencies of two-tone CW signals.

The device 2a receiver architecture may be based on RF envelope detector, intermediate frequency (IF) envelope detector (ED), i.e., heterodyne receiver, or homodyne receiver with zero IF, as exemplified for device 2b.

The device 2b shares similar structure at large with the device 2a other than the UL signal is internally generated using LO rather than backscattering the externally provided CW. The example architecture shown in FIGS. 12-14 is based on an active transmitter chain, wherein the UL data is modulated, converted to an analog signal using digital to analog converter (DAC) and, then up-converted to a UL carrier frequency using LO and frequency mixer, which is followed by an amplifier.

In FIG. 12, the DL receiver chain is still based on the RF envelope detector as in the previous architectures. In FIG. 13, the DL receiver chain is based on heterodyne receiver with IF envelope detector. In the heterodyne architecture, the RF signal is down converted into an intermediate frequency and then detected using an envelope detector. In FIG. 14, the DL receiver is based on homodyne receiver, i.e., zero-IF. In the homodyne/zero-IF architecture, the RF signal is directly down converted into baseband signal and then detected using a comparator/ADC.

FIGS. 9-14 should be understood for illustration purpose only. There can be other components not explicitly shown in the figure such as switch, duplexer, and filters, or some components may be replaced to different options. Also, the devices can operate both in TDD and FDD spectrum, either licensed or unlicensed, and, depending on the operating spectrum, the actual architectures can be different from the conceptual illustrations in the figures.

For R2D transmission at least OOK modulation is used. For D2R transmission, one or more of OOK, binary PSK, binary FSK can be used. The general principle for OOK signal generation based on CP-OFDM waveform includes encoding OOK chips generated by encoding schemes on top of CM-OFDM waveform. Such encoding schemes include Manchester encoding, PIE (Pulse-Interval Encoding), Miller encoding, FM0 encoding, any other types of line-coding schemes, or even no line-coding schemes such as based on square-wave modulation. The following OOK schemes based on CP-OFDM waveform can be taken into account.
OOK-1: Single-chip in 1 OFDM symbol. OOK=1 means N sub-carriers (SCs) are modulated. OOK-0 means SCs are zero power (from base-band point of view).
OOK-2: Parallel M-bit OOK in frequency domain. N SCs are further separated into M segments with guard-bands in-between and/or around. OOK=1 means SCs in segment are modulated. OOK-0 means SCs in segment are zero power (from base-band point of view).
OOK-3: Multi-tone single-bit OOK. N SCs are separated into L segments without guard-bands in-between segment, but around. OOK=1 means 1 sub-carrier (known by receiver) of each segment is modulated, rest of SC is zero power (from base-band point of view). OOK=0 means SCs in segments are zero power (from base-band point of view).
OOK-4: Transform M-bit OOK in time domain. N SCs of OOK-1 are generated by a transformation (DFT/Least square). N′ samples are generated from M-bits. Signal modification and/or truncation may or may not be used. The resulting samples, N, are mapped to N SCs.

The disclosure is applicable to any encoding schemes, any OOK modulation schemes with different M values if applicable, or any underlying waveforms such as CP-OFDM or its variants including DFT-s-OFDM, etc.

In deploying A-IoT devices, different topology options can be evaluated. The following provides examples of topology options:
Topology 1: BS↔A-IoT device.
   An A-IoT device directly and bidirectionally communicates with a basestation. The communication between the basestation and the A-IoT device includes A-IoT data and/or signalling. This topology includes the BS transmitting to the A-IoT device is different from the BS receiving from the A-IoT device.
Topology 2: BS ↔intermediate node ↔Ambient IoT device
   An A-IoT device communicates bidirectionally with an intermediate node between the device and basestation. In this topology, the intermediate node can be a relay, IAB node, UE, repeater, etc. which is capable of A-IoT. The intermediate node transfers A-IoT data and/or signalling between BS and the A-IoT device. The intermediate node is referred to as I-node in this disclosure.
Topology 3: BS ↔assisting node ↔Ambient IoT device↔BS
   An A-IoT device transmits data/signalling to a basestation, and receives data/signalling from the assisting node; or the A-IoT device receives data/signalling from a basestation and transmits data/signalling to the assisting node. In this topology, the assisting node can be a relay, IAB, UE, repeater, etc. which is capable of A-IoT.
Topology 4: UE ↔Ambient IoT device
   An A-IoT device communicates bidirectionally with a UE. The communication between UE and the A-IoT device includes A-IoT data and/or signalling.

This disclosure is applicable at least to the following deployment scenarios:
Scenario 1: Device indoors, BS indoors
Scenario 2: Device indoors, BS outdoors
Scenario 3: Device indoors, UE-based reader
Scenario 4: Device outdoors, BS outdoors
Scenario 5: Device outdoors, UE-based reader

The deployment of A-IoT can be on the same sites as an existing 3GPP deployment corresponding to the BS type, e.g., macro-cell, micro-cell, pic-cell, etc. In some embodiments, it may be expected that the deployment of A-IoT can be on new sites without an expectation of an existing 3GPP deployment. The deployment can be based on licensed or unlicensed TDD or FDD spectrum, which may be in-band to an existing deployment, in guard-band of an existing deployment, or in a standalone band. Different traffic types can be supported including device-terminated (DT) and device-originated (DO), wherein DO traffic can be further divided into DO autonomous (DO-A), and DO device-terminated triggered (DO-DTT) types.

A-IoT device is one type of a UE. Embodiments in this disclosure can be generally applicable to other types of UEs, e.g., smartphones, AR/VR devices, or any other types of IoT devices.

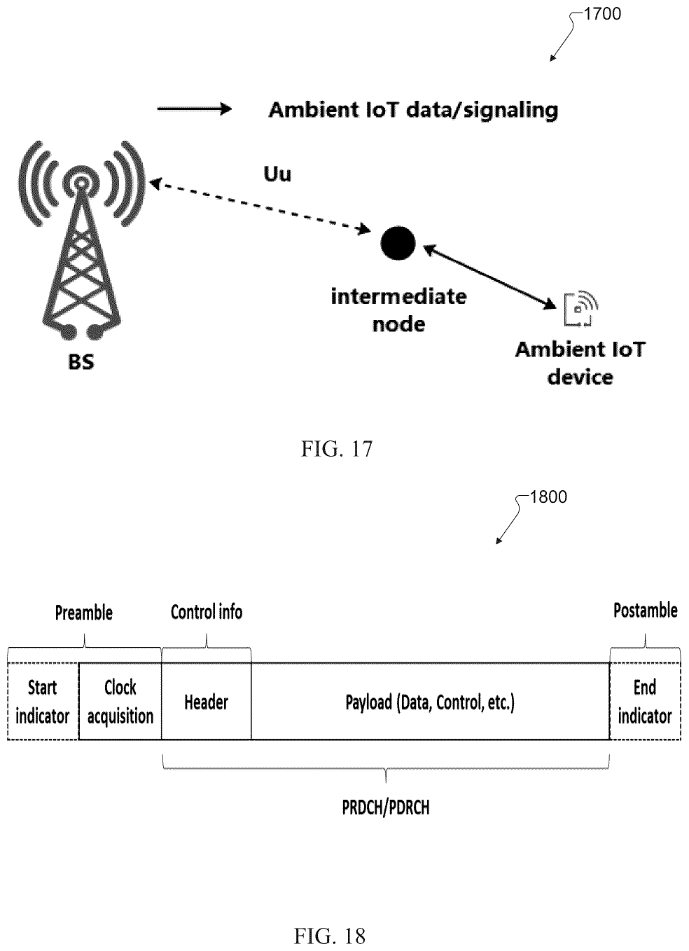

FIG. 17 illustrates an example system 1700 for D2R/R2D transmission including an intermediate UE according to embodiments of the present disclosure. For example, system 1700 can be implemented in the wireless network 100 of FIG. 1. This example is for illustration only and other embodiments can be used without departing from the scope of the present disclosure.

With reference to FIG. 17, a topology involving an intermediate node is shown, wherein the intermediate node (I-node) can be any of a UE, relay, repeater, a dedicated node, or a gNB (e.g., the BS 102). Any operations performed by a BS can be also performed by the I-node instead of the BS, and all or part of interfaces are transparent to the A-IoT devices.

An entity directly communicating with a device, or tag, is collectively termed as a reader, which can be an intermediate node as illustrated in FIG. 17, an assisting node, a UE, or a BS directly communicating with a device.

This disclosure is applicable to any of the following spectrum options, wherein a reader can be any of a BS, an intermediate node, an assisting node, or a UE in any of the topologies or scenarios disclosed herein:
The scenario when a reader is an intermediate node, an assisting node, or a UE
   CW is transmitted on DL spectrum and D2R is transmitted on the DL spectrum or shifted to UL spectrum.
   CW is transmitted on UL spectrum and D2R is transmitted on the UL spectrum or shifted to DL spectrum.
   R2D transmission by a reader is on DL spectrum or UL spectrum.
   A node transmitting the CW can be a node inside the topology, e.g., a BS, an intermediate node, an assisting node, or a UE, or a node outside the topology, e.g., a dedicated CW source.
   A reader receiving D2R transmission and a reader transmitting R2D may be the same or different.
   As an example, CW is transmitted on DL spectrum and D2R transmission is shifted to UL spectrum, wherein the node transmitting the CW is a node inside topology or outside topology, and a reader transmitting R2D and a reader receiving D2R may be the same or different.
   As another example, CW is transmitted on DL or UL spectrum and D2R transmission is on the same spectrum for which the CW is transmitted, wherein the node transmitting the CW is a node inside topology or outside topology, and a reader transmitting R2D and a reader receiving D2R may be the same or different.

A physical channel for reader to device transmission is referred to as a physical reader to device (R2D) channel (PRDCH), and a physical channel for device to reader transmission is referred to as a physical device to reader (D2R) channel (PDRCH) in this disclosure.

For PRDCH and PDRCH transmission, a timing acquisition signal, e.g., a preamble, is included at least for timing acquisition and for indicating the start of the transmission in time domain, respectively.

There may be a timing relationship between transmissions as below:
T_{R2D_min}, T_{R2D_max}: Minimum/maximum time between a R2D transmission and the corresponding D2R transmission following it.
T_{D2R_min}, T_{D2R_max}: Minimum/maximum time between a D2R transmission and the corresponding R2D transmission following it.
T_{R2D_R2D_min}, T_{R2D_R2D_max}: Minimum/maximum time between two different consecutive R2D transmissions to the same A-IoT device.
T_{D2R_D2R_min}, T_{D2R_D2R_max}: Minimum/maximum time between two different consecutive D2R transmissions from the same A-IoT device.

FIG. 18 illustrates an example signal structure 1800 for A-IoT systems according to embodiments of the present disclosure. For example, signal structure 1800 can be received by any of the devices described herein. This example is for illustration only and other embodiments can be used without departing from the scope of the present disclosure.

With reference to FIG. 18, an example signal structure used for A-IoT system for R2D or D2R transmission according to the disclosure is shown. The dotted block indicates that it may or may not exist.

The figure illustrates a general signal structure comprised of one or more of the following elements:
Start-indicator, i.e., delimiter: Start-of-signal indication. It may be a short duration of low voltage signal or an ON/OFF pattern, i.e., high/low voltage transmission. The start-indicate may present in the PRDCH, and it may not be present in the PDRCH.
Postamble, i.e., end-indicator: It may be a short duration of a low voltage signal or an ON/OFF pattern, i.e., high/low voltage transmission. The postamble may or may not be present depending on the system design. In one example, the presence of the postamble for PRDCH is indicated in the PRDCH control/header part. Similarly, in one example, the attachment of the postamble for PDRCH is indicated in the preceding PRDCH control/header part.
Clock acquisition: A sequence that provides OOK chip rate acquisition, which is used to detect OOK chips for the rest of the signal, and the chip synchronization. The clock acquisition part is a part of preamble.
Header: The header field carries necessary information for R2D or D2R signal reception, providing L1 or L2 control information. When it is L2 control information, the header is a part of the following payload.
Payload: The field provides data including any of L1, L2, or higher layer control information, system information, etc.

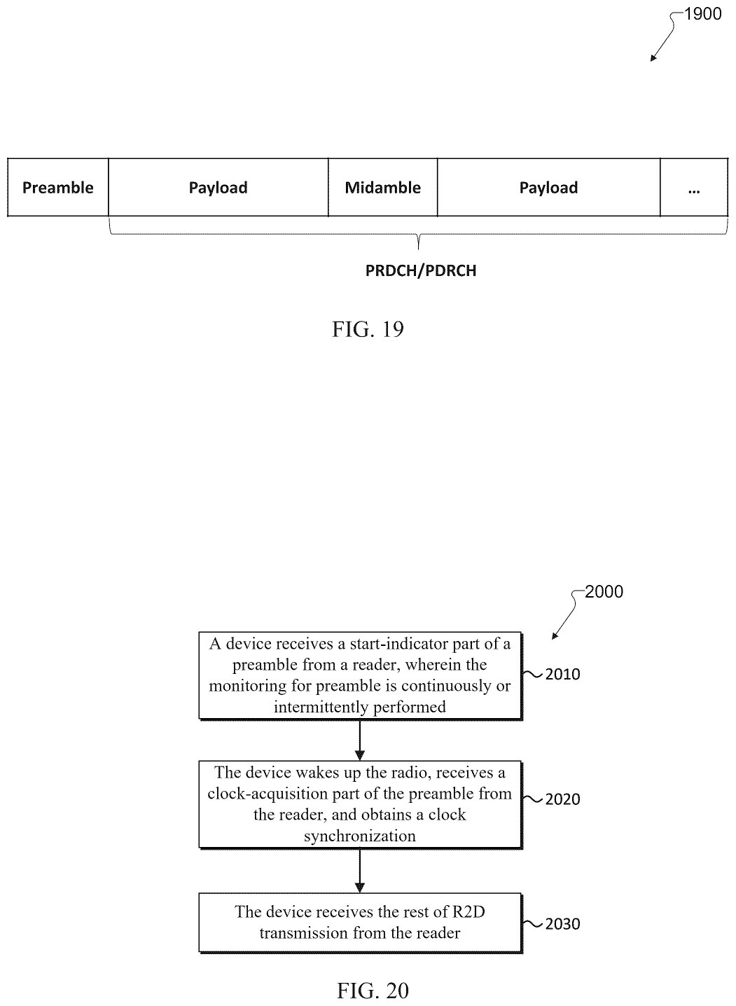

FIG. 19 illustrates an example signal structure 1900 for A-IoT systems with midamble according to embodiments of the present disclosure. For example, signal structure 1900 can be received by any of the devices described herein. This example is for illustration only and other embodiments can be used without departing from the scope of the present disclosure.

With reference to FIG. 19, an example signal structure used for A-IoT system for R2D or D2R transmission with midamble according to the disclosure is shown.

When a transmission is longer than a certain threshold, which may be predefined in a specification of system operations or indicated to the device for reception or transmission from the device, the payload may be divided into multiple segments with midamble. A single header for the entire payload, or one or more headers for each segments of the payload may be provided. When the header is L2 control information, it is a part of the payload. A single CRC for the entire payload (either inclusive or non-inclusive of the header) or one or more CRCs for each segments of the payload may be provided.

In one example, the insertion of the midamble is only for PDRCH. In another example, the insertion of the midamble is both for PDRCH and PRDCH.

In one example, the payloads segmented by the midambles are not attached with a separate control/header field. In another example, the payloads segmented by the midambles are attached with separate control/header field. In one example, the entire transmission is regarded as one PRDCH or PDRCH. In another example, the midamble is not regarded as a part of PRDCH or PDRCH and the transmissions separated by the midamble are regarded as a separate PRDCH to your PDRCH.

The disclosure relates to a communication system. Embodiments of the present disclosure recognize that defining functionalities and procedures for communication with A-IoT devices which may be lacking a precise timing capability and may operate in a passive or active D2R transmission mode is needed.

Embodiments of the present disclosure further recognize that defining functionalities and procedures for A-IoT devices to transmit a D2R signal and receive a R2D signal in an asynchronous manner with a lack of precise synchronization maintenance capability is needed.

Embodiments of the present disclosure further recognize that defining signal/channel structure for communication between A-IoT devices and a reader including fields for SFO/CFO estimation, channel/interference estimation, and noise estimation is needed.

Embodiments of the present disclosure further recognize that defining signal/channel structure for communication between A-IoT devices and a reader including fields for channel/interference estimation during data reception is needed.

Embodiments of the present disclosure further recognize that defining functionalities and procedures for A-IoT devices to provide clock calibration capability to a reader is needed.

Embodiments of the present disclosure further recognize that defining functionalities and procedures for A-IoT reader to estimate timing or frequency drift range for signal detection based on initial or residual SFO/CFO is needed.

Embodiments of the present disclosure further recognize that defining functionalities and procedures for A-IoT devices to determine transport block size (TBS) for PRDCH reception or PDRCH transmission is needed.

Embodiments of the present disclosure further recognize that defining functionalities and procedures for A-IoT devices to determine TBS for two consecutive R2D-R2D transmissions or for two consecutive D2R-D2R transmissions is needed.

Embodiments of the disclosure for communication with A-IoT devices, which may be lacking a precise timing capability and may operate in a passive or active UL transmission mode, are summarized in the following and are fully elaborated further below.
Method and apparatus for defining signal/channel structure for communication between A-IoT devices and a reader including fields for SFO/CFO estimation, channel/interference estimation, and noise estimation.
Method and apparatus for defining signal/channel structure for communication between A-IoT devices and a reader including fields for channel/interference estimation during data reception.
Method and apparatus for defining functionalities and procedures for A-IoT devices to provide clock calibration capability to a reader.
Method and apparatus for defining functionalities and procedures for A-IoT reader to estimate timing or frequency drift range for signal detection based on initial or residual SFO/CFO.
Method and apparatus for defining functionalities and procedures for A-IoT devices to determine TBS for PRDCH reception or PDRCH transmission.
Method and apparatus for defining functionalities and procedures for A-IoT devices to determine TBS for two consecutive R2D-R2D transmissions or for two consecutive D2R-D2R transmissions.

FIG. 20 illustrates a flowchart of an example A-IoT device procedure 2000 for receiving R2D preamble according to embodiments of the present disclosure. For example, procedure 2000 can be performed by any of the devices described herein. This example is for illustration only and other embodiments can be used without departing from the scope of the present disclosure.

The procedure begins in 2010, a device receives a start-indicator part of a preamble from a reader, wherein the monitoring for preamble is continuously or intermittently performed. In 2020, the device wakes up the radio, receives a clock-acquisition part of the preamble from the reader, and obtains a clock synchronization. In 2030, the device receives the rest of R2D transmission from the reader.

With reference to FIG. 20, an example flowchart is shown of an A-IoT device to receive R2D preamble according to the disclosure.

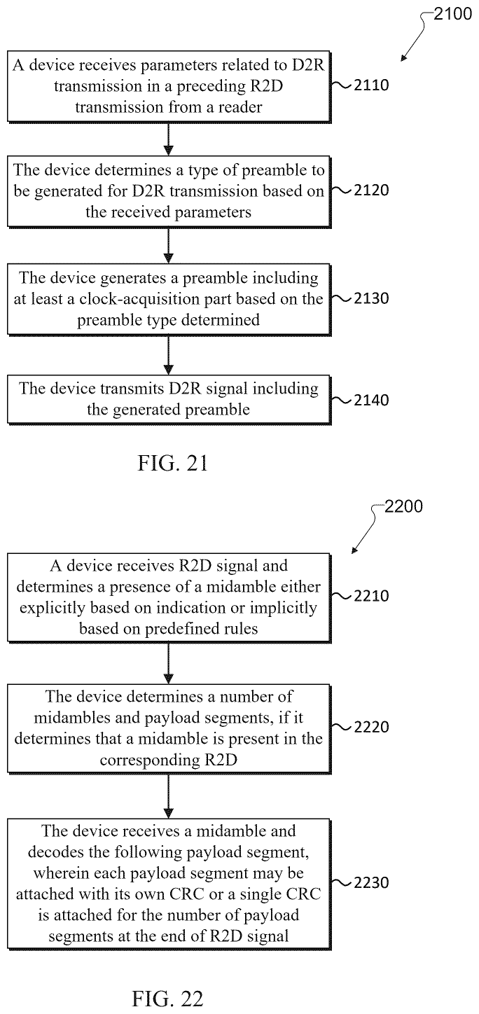

FIG. 21 illustrates a flowchart of an example A-IoT device procedure 2100 for generating D2R preamble according to embodiments of the present disclosure. For example, procedure 2100 can be performed by any of the devices described herein. This example is for illustration only and other embodiments can be used without departing from the scope of the present disclosure.

The procedure begins in 2110, a device receives parameters related to D2R transmission in a preceding R2D transmission from a reader. In 2120, the device determines a type of preamble to be generated for D2R transmission based on the received parameters. In 2130, the device generates a preamble including at least a clock-acquisition part based on the preamble type determined. In 2140, the device transmits D2R signal including the generated preamble.

With reference to FIG. 21, an example flowchart is shown of an A-IoT device to generate D2R preamble according to the disclosure.

For R2D, the preamble includes a start-indicator part and a clock-acquisition part, as illustrated in FIG. 20. In one example, the start-indicator, i.e., delimiter, can be a fixed length low voltage signal. The start-indicator field may be also utilized for the purpose of wake-up signal (WUS) for devices to stay in a sleep mode until the start-indicator field is detected. Therefore, in another example, the start-indicator field may not be a simple fixed length low voltage signal, but it can be a short sequence that can facilitate the detection of the signal for the purpose of WUS. As an example, it can be a certain high/low-voltage pattern of a signal for a certain duration. In another example, it is encoded with a number of bits, e.g., 00, 01, 10, or 11. In another example, the start-indicator part is an encoded signal of 10101011.

For D2R, the preamble may not include a start-indicator part as the D2R transmission is triggered by a reader and, thus, the start timing of D2R transmissions is known by the reader. In another example, the D2R preamble also include a start-indicator part, wherein the design of the start-indicator part can be similar to that of R2D preamble.

The clock acquisition part can be a sequence transmitted in time domain providing timing synchronization for the demodulation of the following fields, such as header and payload. It may be also used for channel estimation and setting up the AGC, etc. The design of clock acquisition part will be dependent on the used encoding schemes. For instance, in the case of PIE encoding, the clock acquisition part needs to provide a calibration for signal pulse durations for bit 0 and 1, as bit 1 has different pulse duration than bit 0. In the case of Manchester encoding, the clock acquisition part can be comprised of a sufficient number of alternations between 0 and 1 for providing a synchronization, while the signal for bit 0 and 1 has a fixed length. In one example, the clock-acquisition part is an encoded signal of 1010, 10101010, etc.

For R2D, since the preamble is the first signal received by a device without a prior knowledge, in one example, the preamble signal structure is fixed, which does not require a blind detection at a device side.

Similarly, for D2R, the design of clock acquisition part will be dependent on the used encoding schemes, i.e., Manchester, FM0, and Miller encoding schemes. Since D2R transmissions are triggered by a reader, the reader may indicate a format of the clock acquisition part to a device, e.g., long and short formats, used for the subsequent D2R transmissions in the preceding R2D control information. The use of different formats, e.g., long and short formats, may be predefined in the specifications based on a certain condition, e.g., packet length, D2R transmission duration or type, etc. As an example, if the payload size is greater than a certain predefined threshold, the device attaches a long preamble format. Otherwise, the device attaches a short preamble format. In another example, if the D2R message type falls into one of a predefined set of message types, the device attaches a long preamble. Otherwise, the device attaches a long preamble format. In one example, the preamble format indication in the R2D control information overrides the predefined rule for applying long or short preamble. In another example, the device follows the predefined rule regardless of the indication. That is, if a certain condition is met, a device uses a predefined format regardless of the presence or the value of the indication.

When PIE encoding is used, in one example, the clock-acquisition part is comprised of 01, followed by a pulse providing device to reader calibration for D2R transmission, wherein the D2R calibration signal may or may not be present. As an example, a device can assume that the D2R calibration is present in a preamble for a certain set of PRDCH message types, while the D2R calibration is not present in a preamble for some other PRDCH message types.

When FM0 encoding is used, the clock-acquisition part is comprised a number of alternations of 1 and 0, followed by v1, wherein v is a low-voltage state for a given chip duration. In one example, the clock-acquisition part is 1010v1, i.e., short format. In another example, 1010v1 is preceded by a number of zeros, i.e., long format. For D2R preamble, a type of preamble is indicated in the preceding R2D control information or determined by the device based on a predefined condition as disclosed herein.

When Miller encoding is used, in one example, the clock-acquisition part starts with a number of zeros followed by a sequence of 0 and 1. In one example, the clock-acquisition part starts with a first number of zeros followed by 010111, i.e., a short format. In another example, the clock-acquisition part starts with a second number of zeros followed by 010111, i.e., a long format. For D2R preamble, a type of preamble is indicated in the preceding R2D control information or determined by the device based on a predefined condition as disclosed herein.

A device monitors a start-indicator part of a preamble from a reader continuously or intermittently. In one example, the device monitors a preamble continuously as long as the device has energy to operate. When the device is running out of energy, the device goes into energy harvesting and charging mode and the device resumes monitoring when it is sufficiently recharged, e.g., the stored energy level exceeds a certain threshold. In another example, the device monitors a preamble with a certain time pattern with on-duration and off-duration. The periodicity and on/off-duration for monitoring a preamble may be based on device-specific charging time and discharging time, which maybe pre-programmed during implementation or calculated during the operation. The periodicity and on/off-duration, and offset that determines the timing for monitoring a preamble may be assumed only by the device itself. In another example, a reader may request a device to report the duty cycle related parameters, as disclosed herein, and the device may reply accordingly. In yet another example, a device reports to the reader the duty cycle related parameters, when it first communicates with the reader, periodically, or aperiodically when parameters are updated.

FIG. 22 illustrates a flowchart of an example A-IoT device procedure 2200 for receiving R2D preamble according to embodiments of the present disclosure. For example, procedure 2200 can be performed by any of the devices described herein. This example is for illustration only and other embodiments can be used without departing from the scope of the present disclosure.

The procedure begins in 2210, a device receives R2D signal and determines a presence of a midamble either explicitly based on indication or implicitly based on predefined rules. In 2220, the device determines a number of midambles and payload segments, if it determines that a midamble is present in the corresponding R2D. In 2230, the device receives a midamble and decodes the following payload segment, wherein each payload segment may be attached with its own CRC or a single CRC is attached for the number of payload segments at the end of R2D signal.

With reference to FIG. 22, an example flowchart is shown of an A-IoT device to receive R2D preamble according to the disclosure.

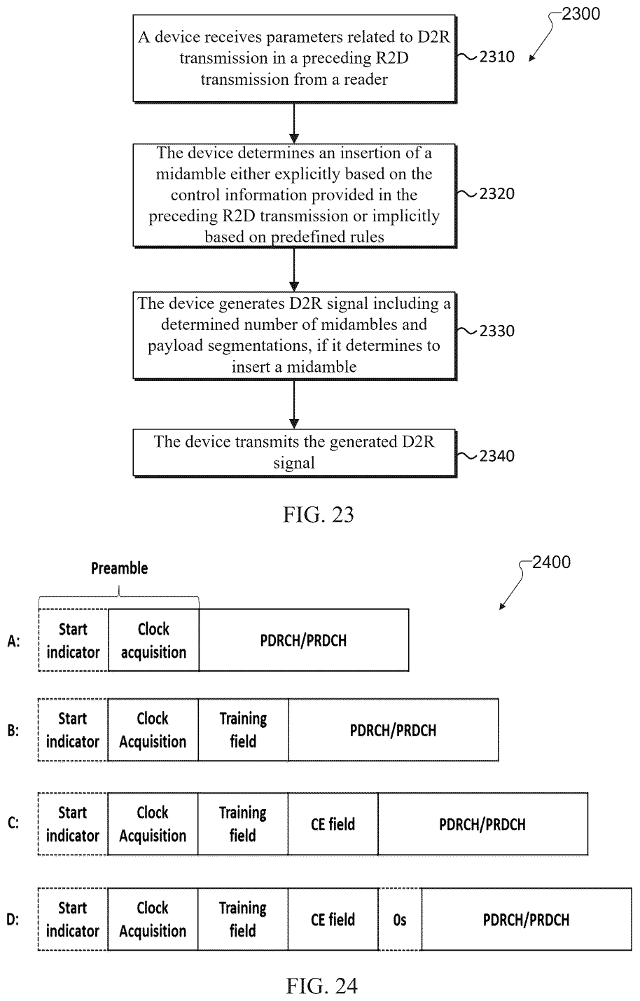

FIG. 23 illustrates a flowchart of an example A-IoT device procedure 2300 for generating D2R preamble according to embodiments of the present disclosure. For example, procedure 2300 can be performed by any of the devices described herein. This example is for illustration only and other embodiments can be used without departing from the scope of the present disclosure.

The procedure begins in 2310, a device receives parameters related to D2R transmission in a preceding R2D transmission from a reader. In 2320, the device determines an insertion of a midamble either explicitly based on the control information provided in the preceding R2D transmission or implicitly based on predefined rules. In 2330, the device generates D2R signal including a determined number of midambles and payload segmentations, if it determines to insert a midamble. In 2340, the device transmits the generated D2R signal.

With reference to FIG. 23, an example flowchart is shown of an A-IoT device to generate D2R preamble according to the disclosure.

For D2R transmission, an insertion of a midamble may be explicitly indicated by a reader in the preceding R2D transmission, e.g., PRDCH providing control information. In one example, it can be a simple on/off indication, and the device performs payload segmentation assuming a predefined payload size per segment if indicated that midamble is turned on. In another example, the R2D control information may provide a number of midambles, a number of payload segmentations, and/or payload size per segment.

The insertion of a midamble may be also implicit as described for PRDCH, i.e., based on the PDRCH message type and/or the PDRCH payload size.

For R2D transmission, the presence of a midamble may be either explicitly or implicitly known by a target device. As an example of an explicit indication, the header field of PRDCH may provide an indication regarding midamble, such as a number of payload segmentations and the size of each payload, which may be identical. Each payload segments, other than the first payload segment, is immediately preceded by a midamble. The first payload segment is not accompanied by a midamble as it follows the preamble. An implicit indication may be based on the PRDCH message type and/or the payload size indicated in the header of the PRDCH.

For instance, if the PRDCH message type falls into one of a predefined set of message types, or the indicated payload size is greater than a certain predefined threshold, the device assumes payload segmentation based on a predefined payload segment size, and a number of midambles correspondingly.

For D2R transmission, an insertion of a midamble may be explicitly indicated by a reader in the preceding R2D transmission, e.g., PRDCH providing control information. In one example, it can be a simple on/off indication, and the device performs payload segmentation assuming a predefined payload size per segment if indicated that midamble is turned on. In another example, the R2D control information may provide a number of midambles, a number of payload segmentations, and/or payload size per segment.

The insertion of a midamble may be also implicit as described for PRDCH, i.e., based on the PDRCH message type and/or the PDRCH payload size.

For both R2D and D2R transmissions, the control field, i.e., header, may be attached with a separate CRC, e.g., CRC-6.

For both R2D and D2R transmissions, each of the payload segment can be attached with a separate CRC, which helps to decode payloads sequentially without waiting for the end of the signal reception and requires less memory buffer size at the receiver.

FIG. 24 illustrates examples of signal structures 2400 according to embodiments of the present disclosure. For example, signal structures 2400 can be received by any of the devices described herein. This example is for illustration only and other embodiments can be used without departing from the scope of the present disclosure.

With reference to FIG. 24, variations of signal structure according to the disclosure is shown. The examples in the figure are for illustration purpose only. An exact placement of each block in the figure can be different and the figure should not be interpreted as a limitation.

Example A in FIG. 24 illustrates the basic signal structure, wherein a preamble includes a start indicator part and clock acquisition part, and the preamble is followed by PDRCH or PRDCH. The start indicator part may not exist when the preamble is followed by PDRCH, while it may exist when the preamble is followed by PRDCH. From the clock acquisition part, a receiver can perform sampling frequency offset (SFO) estimation, carrier frequency offset (CFO) estimation, channel estimation, or interference estimation.

Example B in FIG. 24 illustrates a signal structure including a training field, wherein the placement of the training field does not need to be exact and it can be different, e.g., before or after the clock acquisition part. In one embodiment, a training field is transmitted and received before a PRDCH or PDRCH. From the clock acquisition part, a receiver can perform SFO estimation, CFO estimation, channel estimation, or interference estimation. The training field is used by a receiver, i.e., a device for PRDCH and a reader for PDRCH, to acquire time and/or frequency synchronization. Using the clock acquisition part, a receiver may acquire a coarse time and/or frequency synchronization. Using the training field, a receiver may refine time and/or frequency synchronization. The training field can be also utilized for channel estimation between the intended transmitter and receiver pair or interference from unintended transmitter. In one example, the training field is transmitted before PDRCH when the device is device 2b, and the training field is used by a reader for CFO estimation.

The training field may be regarded as a part of preamble. In another example, the training field is not regarded as a part of preamble and the training field is placed after the preceding preamble and before a PRDCH or PDRCH. For PRDCH, the existence of the training field may be predefined in a specification of a system operation, indicated by the preceding preamble, e.g., indication based on a used pattern or sequence of the clock acquisition part, or indicated in the control field of the following PRDCH. For the PDRCH, the inclusion of the training field may be predefined in a specification of a system operation, indicated by the preceding preamble, or indicated in the control field of the preceding PRDCH. In one example, the training field is present in PRDCH or PDRCH. In another example, the training field is present in PRDCH or PDRCH when the device is device 2a or 2b.

Example C in FIG. 24 illustrates a signal structure including a channel estimation (CE) field, wherein the placement of the CE field does not need to be exact and it can be different, e.g., before or after the clock acquisition part or the training field, if exists. In one embodiment, the CE field is transmitted and received before a PRDCH or PDRCH, wherein the training field may present or may not present. The CE field can be utilized for channel estimation between the intended transmitter and receiver pair or interference from unintended transmitter. In one example, the CE field is transmitted before PDRCH when the device is device 2b, and the CE field is used by a reader for channel and/or interference estimation.

The CE field may be regarded as a part of preamble. In another example, the CE field is not regarded as a part of preamble and the CE field is placed after the preceding preamble and before a PRDCH or PDRCH. For PRDCH, the existence of the CE field may be predefined in a specification of a system operation, indicated by the preceding preamble, e.g., indication based on a used pattern or sequence of the clock acquisition part, or indicated in the control field of the following PRDCH. For the PDRCH, the inclusion of the CE field may be predefined in a specification of a system operation, indicated by the preceding preamble, or indicated in the control field of the preceding PRDCH. In one example, the CE field is present in PRDCH or PDRCH. In another example, the CE field is present in PRDCH or PDRCH when the device is device 2a or 2b.

Example D in FIG. 24 illustrates a signal structure including a number of 0s, wherein the placement of the 0s does not need to be exact and it can be different, e.g., before or after the clock acquisition part, the training field, if exists, or the CE field, if exists. In one embodiment, a number of 0s are transmitted and received before a PRDCH or PDRCH, wherein the training field and/or CE field may present or may not present. The 0s can be utilized for estimating noise power and/or interference from unintended transmitter. The 0s are a consecutive transmission of 0s for a predetermined number of times, N, wherein the number N is predefined in a specification of a system operation. The 0 can be a baseband information bit 0 before line encoding. In another example, the 0 can be a chip-level 0, i.e., a low voltage state of a chip. In yet another example, the 0s can be a certain fixed duration of no transmission wherein the duration can be defined in a number of OFDM symbols, chips with a fixed length, e.g., expecting a certain OOK-4 M value wherein the M value can be the minimum or the maximum value supported in the system, chips with a variable length, e.g., expecting OOK-4 with M value used in the PRDCH or indicated for PDRCH, or an absolute time duration in ms, μs, etc.

The 0s may be regarded as a part of preamble. In another example, the 0s are not regarded as a part of preamble and the 0s are placed after the preceding preamble and before a PRDCH or PDRCH. For PRDCH, the existence of the 0s may be predefined in a specification of a system operation, indicated by the preceding preamble, e.g., indication based on a used pattern or sequence of the clock acquisition part, or indicated in the control field of the following PRDCH. For the PDRCH, the inclusion of the 0s may be predefined in a specification of a system operation, indicated by the preceding preamble, or indicated in the control field of the preceding PRDCH. In one example, the 0s are present in PRDCH or PDRCH. In another example, the 0s present in PRDCH or PDRCH when the device is device 2a or 2b.

Any combination of the training field, CE field, and 0s may be present or indicated to be present for a device prior to PRDCH reception or prior to PDRCH transmission. In one example, the clock acquisition part, the training field, or the CE field is based on Golay sequences. In one example, there is a pair of Golay complementary sequences, denoted by Ga_{N}, Gb_{N}, and the clock acquisition part, the training field, or the CE field is comprised of a number of Ga_{N}, Gb_{N}, −Ga_{N}, or −Gb_{N}. In one example, the clock acquisition part, the training field, or the CE field is comprised as {Ga_{N}, . . . , Ga_{N}, Ga_{N}, −Ga_{N}}. In another example, the clock acquisition part, the training field, or the CE field is comprised as {Gb_{N}, . . . , Gb_{N}, −Gb_{N}, −Ga_{N}}.

In yet another example, a number of Ga_{N}, Gb_{N}, −Ga_{N}, or −Gb_{N} are group into Gu_{M} and Gv_{M}, where M/N is the number of Ga_{N}, Gb_{N}, −Ga_{N}, or −Gb_{N} sequences grouped into Gu_{M} and Gv_{M}. In one example, Gu_{M}={−Gb_{N}, −Ga_{N}, Gb_{N}, −Ga_{N}}, Gv_{M}={−Gb_{N}, Ga_{N}, −Gb_{N}, −Ga_{N}}, and Gv_{N}=−Gb_{N}. In one example, the clock acquisition part, the training field, or the CE field is comprised as {Gu_{M}, Gv_{M}, Gv_{N}}. In another example, the clock acquisition part, the training field, or the CE field is comprised as {Gv_{M}, Gu_{M}, Gv_{N}}.

In yet another example, any of the fields herein may be comprised of a consecutive zeros in bit, which is represented as a series of chips for a given line encoding scheme. For instance, the bit-0 can be represented as chip {01}, or {10}.

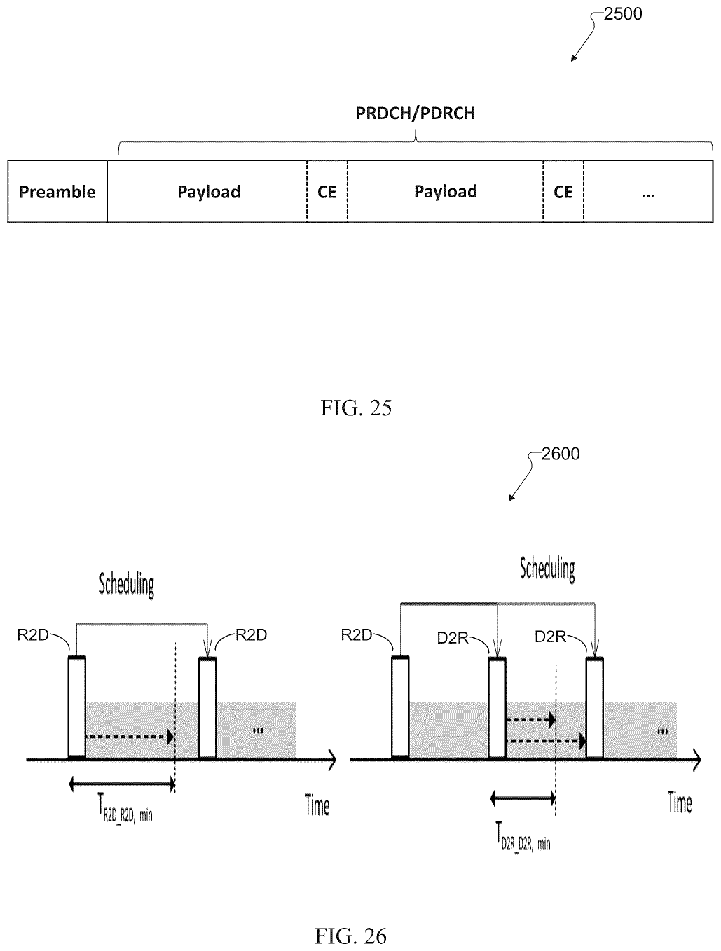

FIG. 25 illustrates an example signal structure 2500 for A-IoT systems with CE field according to embodiments of the present disclosure. For example, signal structure 2500 can be received by any of the devices described herein. This example is for illustration only and other embodiments can be used without departing from the scope of the present disclosure.

With reference to FIG. 25, channel estimation (CE) field inserted in the PRDCH or PDRCH according to the disclosure is shown. The CE field may be referred to as a midamble. The CE field inserted in the data field of PRDCH or PDRCH can be utilized for channel estimation between the intended transmitter and receiver pair or interference from unintended transmitter.

In one example, the CE field is inserted every N number of information bits before line encoding, every N number of bits after FEC, e.g., convolutional code, and after or before CRC attachment, or every N number of chips after line encoding. In yet another example, the CE field is inserted every N number of underlying OFDM symbols. For instance, the data field is segmented into N number of information bits, coded bits, chips, or OFDM symbols and each segment is appended with the CE field.

The insertion of the CE field may be predefined in a specification of a system operation, indicated by the preceding preamble, e.g., indication based on a used pattern or sequence of the clock acquisition part, or indicated in the control field of the corresponding PRDCH. For the PDRCH, the insertion of the CE field may be predefined in a specification of a system operation, or indicated in the control field of the preceding PRDCH. In one example, the CE field in the data field is present in PRDCH or PDRCH. In another example, the CE field in the data field of PRDCH or PDRCH is present when the device is device 2a or 2b.

When the last segment is not fully occupied with N number of information bits, coded bits, chips, or OFDM symbols, the last segment is transmitted as is, i.e., not fully occupied, and it may be appended with a CE field or may not be appended with a CE field, which is predefined in a specification of system operation or indicated for PRDCH or PDRCH. In another example, the last partially occupied segment is padded to N number of information bits, coded bits, chips, or OFDM symbols.

As an example, the last partially occupied segment is padded with
A number of consecutive OOK chips of {1}.
A number of consecutive OOK chips of {0}.
A number of consecutive OOK chips of {01}.
A number of consecutive OOK chips of {10}.
A number of consecutive data bits of {0}, which is mapped to OOK chips, e.g., bit 0→chips {10}.
A number of consecutive data bits of {1}, which is mapped to OOK chips, e.g., bit 1→chips {01}.
A number of consecutive data bits of {01}.
A number of consecutive data bits of {10}.

The last segment after padding may be appended with a CE field or may not be appended with a CE field, which is predefined in a specification of system operation or indicated for PRDCH or PDRCH.

For each of the segment with N number of information bits, coded bits, chips, or OFDM symbols, the FEC, e.g., convolutional coding, is performed separately. In another example, the FEC is performed for the entire data field. For each of the segment with N number of information bits, coded bits, chips, or OFDM symbols, the CRC is added separately. In another example, the CRC is added for the entire data field or for the entire control and data fields.

In one example, the CE field is comprised of a number of alternations between 0 and 1 of bits before line encoding or between 0 (low voltage) and 1 (high voltage) chips. As an example, the CE field is 101010 . . . bits or chips. In another example, the CE field is comprised of a Golay sequence and detailed examples provided for the training/CE field herein is applicable for the CE field. In yet another example, the CE field is a consecutive zeros in bit, which is represented as a series of chips for a given line encoding scheme. For instance, the bit-0 can be represented as chip {01}, or {10}.

A device may or may not be able to calibrate the device clock for D2R transmission by using R2D signal/channel including preamble, any of the additional fields disclosed herein such as training and CE fields, and PRDCH itself.

In one example, a device is not able to calibrate the device clock for D2R transmission and the device transmits with initial SFO and/or CFO. When the reader is an intermediate-UE based reader, the reader receives information related to SFO and/or CFO range or value to be assumed for D2R reception. When the reader is gNB (e.g., the BS 102), the reader assumes SFO/CFO range or value by itself. In one example, SFO/CFO range is provided, e.g., [10^{X}˜10^{Y}] ppm. In another example, a single SFO/CFO value is provided, e.g., 10^{Y} ppm. A single SFO/CFO range or value is provided to the reader, which applies to the devices. In another example, the provided SFO/CFO range or value is associated with a device ID or device group ID.

Based on the provided SFO and/or CFO range/value, the reader estimates a possible timing drift range. Denote by T the time gap from a reference timing, i.e., PRDCH triggering the PDRCH, and the indicated PDRCH transmission timing, wherein the PRDCH timing can be the end of PRDCH or the preamble preceding the PRDCH. As an example, denote by Or the timing drift in a unit time derived from the indicated/assumed SFO value. Similarly, denote by F the carrier frequency for the D2R transmission and denote by OF the frequency drift derived/assumed from the indicated CFO value. In one example, a reader assumes a possible PDRCH reception timing range from the reference timing as [T(1−δ_{T}), T(1+δ_{T})], wherein the timing range increases with the time gap T from the reference timing. Similarly, a reader assumes a possible PDRCH reception frequency range from the intended carrier frequency F as [F(1−δ_{F}), F(1+δ_{F})], wherein the frequency range increases with the carrier frequency F. Based on the assumed PDRCH reception timing range or frequency range, the reader searches possible PDRCH reception in time or frequency.

In another example, a device is able to calibrate the device clock for D2R transmission and the device transmits with residual SFO and/or CFO after calibration. In one embodiment, a device reports its calibration capability on SFO and/or CFO to the reader. In yet another example, the device reports its residual SFO/CFO range or value to the reader. In yet another example, devices are required to perform clock calibration and meet a certain residual SFO/CFO requirement.

Similar to the previous case wherein the device is unable to calibrate the device clock, the reader assumes a possible timing range [T(1−δ_{T}), T(1+δ_{T})] and/or frequency range [F(1−δ_{F}), F(1+δ_{F})] based on the residual SFO/CFO, instead of the initial SFO/CFO, based on the reporting or assumed value. When the reader is an intermediate-UE based reader, the reader receives information related to residual SFO/CFO range or value to be assumed for D2R reception from one or more devices or from the serving gNB. When the reader is gNB, the reader assumes residual SFO/CFO range or value by itself. In one example, a single residual SFO/CFO range or value is provided to the reader, which applies to the devices. In another example, the provided residual SFO/CFO range or value is associated with a device ID or device group ID. Based on the assumed PDRCH reception timing range or frequency range, the reader searches possible PDRCH reception.

A device determines transmission block size (TBS) for PRDCH reception or PDRCH transmission.

The followings can be used as an input for the TBS determination by a device for PRDCH reception or PDRCH transmission:
A time domain resource allocation: As an example, it can be a number of OFDM symbols, ms, etc. In one example, the time domain resource may be indicated by an index to a set of predefined time domain resource sizes, wherein the predefined time domain resource sizes are defined in a specification of a system operation and an index corresponds to a codepoint indicating a certain predefined time domain resource size.
Modulation related information:
   For PRDCH, OOK modulation is used.
      When OOK-1 is indicated, 1 chip per OFDM symbol is transmitted.
      When OOK-4 with factor M is indicated, M chip per OFDM symbol is transmitted.
      When line encoding is applied, a number of chips represent a bit. For instance, for Manchester encoding, chips {10} represent bit-0, and chips {01} represent bit-1. For FM0 and Miller encoding, it can be similarly understood. Denote by K the number of chips to represent a bit. Then M/K bits can be transmitted in one OFDM symbol.
      When PIE encoding is used, data rate is calculated as SF/TRcal, where SF is a scaling factor indicated in the control field of the PRDCH and TRcal is a length of a D2R PIE calibration signal in the clock-acquisition part of the preceding preamble. In one example, the scaling factor may be indicated by an index to a set of predefined scaling factors, wherein the predefined scaling factors are defined in a specification of a system operation and an index corresponds to a codepoint indicating a certain predefined scaling factors. For Manchester or FM0, the data rate is calculated as SF/TRcal. For Miller encoding, the data rate is calculated as SF/TRcal/M_{Miller}, wherein M_{Miller} subcarrier factor. In one example, the M_{Miller} may be indicated by an index to a set of predefined M_{Miller} values, wherein the predefined M_{Miller} values are defined in a specification of a system operation and an index corresponds to a codepoint indicating a certain predefined M_{Miller} value. In one example, the set of predefined M_{Miller} value includes {2, 4, 8, reserved}. In this example, 2-bit indication is used, wherein each codepoint 00, 01, 10, 11, corresponds to one of a M_{Miller} value from the set of predefined M_{Miller} values.
   For PDRCH, OOK, BPSK, BFSK modulation can be used.
      For OOK modulation, the descriptions provided for PRDCH apply.
      For BPSK/BFSK, one bit per symbol is transmitted. In one example, the BPSK/BFSK symbol rate is directly indicated to the device, e.g., symbols/second, or one symbol duration in time. In another example, a bandwidth for signal transmission is indicated to the device, and the device derives a symbol rate from the indicated transmission bandwidth. For instance, if indicated bandwidth is B, then the BPSK/BFSK symbol rate is derived as B. In another example, if indicated bandwidth is B, then the BPSK/BFSK symbol rate is derived as B/2. In one example, the bandwidth may be indicated by an index to a set of predefined bandwidths, wherein the predefined bandwidths are defined in a specification of a system operation and an index corresponds to a codepoint indicating a certain predefined bandwidth. In one example, the set of predefined bandwidth includes {1 PRB, 2 PRB, 3 PRB, reserved}. In this example, 2-bit indication is used, wherein each codepoint 00, 01, 10, 11, corresponds to one of a bandwidth from the set of predefined bandwidths.
FEC, e.g., convolutional code, code rate: The FEC code rate may be applicable for both PRDCH and PDRCH. In another example, FEC code rate may be applicable only for PDRCH. In one example, the code rate may be indicated by an index to a set of predefined code rates, wherein the predefined code rates are defined in a specification of a system operation and an index corresponds to a codepoint indicating a certain predefined code rate. In one example, the set of predefined code rate includes {1/6, 1/4, 1/3, 1/2}. In this example, 2-bit indication is used, wherein each codepoint 00, 01, 10, 11, corresponds to one of a code rate from the set of predefined code rates.
Repetition factor: The repetition factor may be applicable for both PRDCH and PDRCH. In another example, repetition factor may be applicable only for PDRCH. In one example, the repetition factor may be indicated by an index to a set of predefined repetition factors, wherein the predefined repetition factors are defined in a specification of a system operation and an index corresponds to a codepoint indicating a certain predefined repetition factor. In one example, the set of predefined repetition factor includes {1, 2, 4, reserved}. In this example, 2-bit indication is used, wherein each codepoint 00, 01, 10, 11, corresponds to one of a repetition factor from the set of predefined repetition factors. Similarly, in another example, a scaling factor is indicated by an index to a set of predefined scaling factors, wherein a scaling factor is an inverse of a repetition factor, e.g., repetition factor of 2 corresponds to a scaling factor of ½. In one example, the set of predefined scaling factor includes {1, 0.5, 0.25, reserved}.

Any of the information herein can be provided in the control part of PRDCH for PRDCH reception or in the preceding PRDCH, either control part or data part, for the PDRCH transmission.

Based on the elements herein, the followings are example methods for TBS determination:

$$TBS = S \cdot M / K \cdot C / R .$$

S is a number of OFDM symbols for PRDCH data part for reception or PDRCH data part for transmission.
M/K is a number of bits that can be transmitted in one OFDM symbol for a given OOK-4 with factor M modulation and K, the number of chips to represent a bit for a given line encoding scheme.
C is a code rate, wherein code rate may be applicable for both PRDCH and PDRCH, or it may be applicable only for PDRCH.
R is a repetition factor, wherein code rate may be applicable for both PRDCH and PDRCH, or it may be applicable only for PDRCH.

$$TBS = S \cdot SF / TRcal \cdot C / R .$$

S is a time duration, e.g., in second, for PRDCH data part for reception or PDRCH data part for transmission. If a number of OFDM symbols is indicated as a time domain resource, then S equals to the number of OFDM symbols times the OFDM symbol duration in second.
For Miller encoding, it can be TBS=S·SF/TRcal/MMiller·C/R.
The TBS may be further scaled by a factor of OFDM payload duration/(OFDM payload duration+CP duration) when CP-OFDM is used as an underlying waveform, to account the overhead due to CP insertion.
Other elements are as described before.

$$TBS = S \cdot {Sym}_{rate} \cdot C . R .$$

S is a time duration, e.g., in second, as described before.
Symᵣₐₜₑ is a BPSK/BFSK symbol rate.
The TBS may be further scaled by a factor of OFDM payload duration/(OFDM payload duration+CP duration) as before.
Other elements are as described before.

In another embodiment, the TBS is directly provided in the control part of PRDCH for PRDCH TBS determination or in the preceding PRDCH, either control part or data part, for the PDRCH TBS determination. The TBS indication may be in a number of bits or bytes. In another example, the TBS may be indicated by an index to a set of predefined TBS sizes, wherein the predefined TBS sizes are defined in a specification of a system operation and an index corresponds to a codepoint indicating a certain predefined TBS size.

In one example, a device provides information related to the maximum TBS that it can process for PRDCH reception or PDRCH transmission. In one example, a reader sends a request message for a device to provide the maximum TBS capability. In another example, when a device receives PRDCH, which indicates TBS for PRDCH reception or for PDRCH transmission, the device provides maximum TBS capability if the indicated TBS exceeds its maximum TBS processing capability.

For PDRCH transmission, the indicated TBS in the preceding PRDCH control information for PDRCH can be larger than the buffered data available at the device for encoding. In one example, the device fill in some padding bits, e.g., zeros, to match the indicated TBS. In another example, the device additionally provides energy status report, if the remaining TBS after available data does not exceed the size of energy status report. After that, the device fill in some padding bits, e.g., zeros, to match the indicated TBS. In yet another example, the device additionally provides buffer status report, if the remaining TBS does not exceed the size of buffer status report. After that, the device fill in some padding bits, e.g., zeros, to match the indicated TBS. The energy status report or buffer status report can be transmitted in response to the request message from a reader. In one embodiment, an R2D message can indicate a device to provide an energy status report or buffer status report in the following D2R transmission. The R2D message can indicate one or more particular device ID or device group ID for the reporting. In yet another example, the device shortens the TBS for PDRCH transmission and indicates the reduced TBS in the control part or data part of the corresponding PDRCH. In yet another example, the device performs repetition to fill in the remaining TBS size to match the indicated TBS size. In one example, the device indicates the actual TBS before repetition in the control part or data part of the corresponding PDRCH

The energy status report can be a simple one bit indication on whether the device has a sufficient energy or not. The level of sufficiency, i.e., a threshold, can be predefined in a specification of a system operation or indicated to the device, for instance, in the R2D message triggering the energy status report. In another example, the energy status reporting can include the device's available energy level or the device's expected remaining operation time. In yet another example, the energy status report can include a maximum transmission time duration or a maximum reception time duration that the device can support. In yet another example, the energy status report includes N-bit indication indicating one state out of 2N energy states of the device. The energy states can be defined in terms of the energy level, remaining operation time, maximum transmission time duration, or a maximum reception time duration. In yet another example, the R2D message indicating a device to provide the energy status report can indicate a particular command, including inventory, and the energy status report from the device is expected to provide whether the device can sustain to complete the indicated command or not. When a D2R transmission is expected by the device, but the device is unable to perform the intended D2R transmission, the device may instead transmit an energy status report. The energy status report may be 1-bit indication indicating that it cannot perform the intended D2R transmission. In another example, the energy status report may indicate how long it is expected that the device will become available again.

The buffer status report can be a simple one bit indication on whether the device has a sufficient data to transmit for the indicated TBS for PDRCH transmission in the preceding PRDCH. In another example, the buffer status report indicates available data at the device by indicating an index from a set of predefined buffer size levels or ranges, which are defined in a specification of system operation. The indication can be N bit, wherein each 2N codepoints correspond to a particular buffer size level or range. In one example, the buffer status report is provided for a logical channel identified by its ID, wherein a logical channel may be separately defined for sensing data, electronic product code (EPC) data, device ID data, any user data, etc. In another example, the buffer status report is provided for a certain memory bank of the device's memory, which may be identified by memory bank index. In one example, there are memory bank {00, 01, 10, 11} wherein each codepoint corresponds to one of User memory, EPC memory, device ID memory, and reserved memory, and the device is indicated from a reader a particular memory bank ID to provide buffer status report. Similarly, for a given memory bank, a device may be further indicated an address of the memory to read and provide buffer status report.

In one example, a reader provides one or multiple TBSs each corresponding to payload/data part segmented by a midamble or CE field for PDRCH transmission by a device. In another example, based on the indicated or calculated TBS for PDRCH transmission, the device determines segmentation if the TBS exceeds a certain threshold. The TBS can be split into one or multiple segments having the size of the threshold, while the last segment can have a size smaller than the threshold. In one example, the device may send the last segment with the actual size smaller than other segments. In another example, the device sends the last segment after padding, e.g., 0s, to make each segment sizes are equal. A device may add single CRC for the entire concatenated payload/data parts. In another example a device may add separate CRC for each payload/data part segmented by a midamble or CE field.

FIG. 26 illustrates timelines 2600 of an example consecutive R2D-R2D reception/D2R-D2R transmission according to embodiments of the present disclosure. For example, timelines 2600 can be followed by any of the devices described herein. This example is for illustration only and other embodiments can be used without departing from the scope of the present disclosure.

With reference to FIG. 26, consecutive R2D-R2D reception or D2R-D2R transmission according to the disclosure is shown.

When an R2D transmission follows a preceding R2D transmission, in one example, the reader provides TBS or information related to calculate the TBS, as disclosed herein, for the following PRDCH transmission. Therefore, in this case, the first PRDCH provides PRDCH TBS information for the first and the second PRDCH in the figure. The first PRDCH may also provide other scheduling information for receiving the second PRDCH. In this case, the second PRDCH only includes payload/data part and does not include control part such that payload/data part immediately follows the preceding preamble. In another example, the first PRDCH provides 1-bit indication to indicate the presence of the subsequent second PRDCH.

When two consecutive D2R transmissions are triggered by R2D, the preceding PRDCH provides TBS or information related to calculate the TBS for the first PDRCH and the second PDRCH. In another example, one set of TBS or information related to calculate the TBS is provided to the device, and the device determines to split into two D2R transmissions, wherein the second PDRCH follows preceding PDRCH within [T_{D2R_D2R}, min, T_{D2R_D2R, max}], if the indicated TBS size exceeds a certain threshold, which may be indicated to the device or predefined in a specification of system operation. In yet another example, the preceding PRDCH provides an indication that the device can split the D2R transmission into two PDRCH transmissions. In one example, the indication is 1 bit.

When the preceding PRDCH provides timing information for the following PRDCH, or when PRDCH provides timing information for consecutive D2R-D2R PDRCH transmissions, the time unit for the indication can be one of the followings:
The time unit for the indication is the minimum chip length supported in the system, which corresponds to the largest OOK-4 M value defined to be supported in the specifications of a system operation. In one example, if the largest value of M supported in the system is denoted by Mₘₐₓ, then the time unit for the D2R transmission timing indication is (1/Mₘₐₓ)·T_{symbol}, where T_{symbol} is an underlying CP-OFDM symbol duration. In one example, the T_{symbol} does not include the CP duration. In one example, the T_{symbol} is based on 15 kHz subcarrier spacing or 30 kHz subcarrier spacing. For 15 kHz subcarrier spacing, T_{symbol} is 66.67 μs. In one example, the maximum M value, Mₘₐₓ, supported in the system is 16, 24, or 32. For example, if Mₘₐₓ equals to 16, the time unit for the D2R transmission indication is given by 4.167 us according to the formula described herein.
The time unit for the indication is the time duration to transmit 1 bit expecting minimum chip length supported in the system, which corresponds to the largest OOK-4 M value defined to be supported in the specifications of a system operation. For the case when Manchester encoding is used, two chips are required to represent one bit. Therefore, the time duration for indication can be. 2·(1/Mₘₐₓ)·T_{symbol}. These can be generalized to N_{chip}·(1/Mₘₐₓ)·T_{symbol}, where N_{chip} is the number of chips required to represent a bit for a given encoding scheme. Examples describe for the previous case can be similarly applicable.
The time unit for the indication is the chip length, which corresponds to M value, used for the PRDCH indicating the D2R transmission timing. Examples describe for the previous case can be similarly applicable.
The time unit for the indication is the chip length, which corresponds to M value, indicated for the transmission of the PDRCH by the scheduling PRDCH control field. Examples describe for the previous case can be similarly applicable.
The time unit for the indication is the time duration to transmit 1 bit expecting the chip length, which corresponds to M value, used for the PRDCH indicating the D2R transmission timing. Examples describe for the previous case can be similarly applicable.
The time unit for the indication is the time duration to transmit 1 bit expecting the chip length, which corresponds to M value, indicated for the transmission of the PDRCH by the scheduling PRDCH control field. Examples describe for the previous case can be similarly applicable.
The time unit for the indication is based on the underlying CP-OFDM symbol duration for a given subcarrier spacing. The unit can be one or multiple OFDM symbol durations, e.g., 2, 4, 6, 8, 10, 12, or 14. In one example, the OFDM symbol duration does not include the CP length. In another example, the OFDM symbol duration includes the CP length. For 15 kHz subcarrier spacing, if the symbol duration does not include the CP duration, then the time unit is given by 66.67 μs. If the symbol duration includes the CP duration, the time unit is given by (5.21+66.67) μs for the 0th and 7th OFDM symbol and it is (4.69+66.67) μs for the rest of symbols. In one example, an average CP duration is expected for an OFDM symbol duration such that (5.21+6*4.69)/7=4.76 μs is the expected CP duration. Therefore, an OFDM symbol duration, which is the time unit for the indication, is expected to be (4.76+66.67) μs.
The time unit for the indication is based on the slot duration expecting underlying CP-OFDM subcarrier spacing. The unit can be one or multiple slot durations. For 15 kHz subcarrier spacing, the slot duration is given by 1 ms.
The time unit for the indication is based on μs or ms.
There is a table predefined in a specification of a system operation which defines a set of timing values. For instance, up to 2^{N} timing values can be predefined, and a device is indicated one codepoint using N bit indication in the PRDCH control field.

For R2D-R2D, the second PRDCH transmission timing is indicated from the preceding first PRDCH, e.g., start or end of PRDCH, or preamble reception timing preceding the PRDCH.

For D2R-D2R, the first PDRCH transmission timing is indicated from the preceding PRDCH, e.g., start or end of PRDCH, or preamble reception timing preceding the PRDCH. The second PDRCH transmission timing may be indicated from the first PDRCH or from the preceding first PDRCH, e.g., start or end of PRDCH, or preamble reception timing preceding the PRDCH.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for an Internet of Things (IoT) device to communicate with a reader, the method comprising:
receiving a physical reader-to-device channel (PRDCH) from the reader, wherein the PRDCH provides information related to a physical device-to-reader channel (PDRCH) transmission including at least:
a preamble format to prepend to the PDRCH between a short format and a long format,
an interval for inserting one or more midambles in the PDRCH,
an indicator for appending an additional midamble at an end of the PDRCH, and
other device-to-reader (D2R) scheduling information;
determining, based on reception of the PRDCH, a transmission of the PDRCH to the reader including:
the preamble format,
whether to insert the one or more midambles, and
whether to append the additional midamble; and
transmitting, based on the determination, the PDRCH with a preamble and the one or more midambles.

2. The method of claim 1, wherein the interval for inserting the one or more midambles in the PDRCH is provided as a number of bits after forward error correction (FEC) encoding.

3. The method of claim 1, wherein:
the other D2R scheduling information includes an index from a set of code rates to encode the PDRCH with a forward error correction (FEC) code, and
the set of code rates includes a 1/3 code rate.

4. The method of claim 1, wherein:
the other D2R scheduling information includes an index from a set of repetition factors for the PDRCH, and
the set of repetition factors is {1, 2}.

5. The method of claim 1, wherein the other D2R scheduling information provides a D2R transport block size (TBS) in a unit of bytes.

6. The method of claim 1, wherein:
the other D2R scheduling information provides a D2R transport block size (TBS), and
determining the transmission of the PDRCH further includes determining whether to insert padding bits when an available amount of data at the IoT device is smaller than the D2R TBS.

7. The method of claim 1, wherein:
the other D2R scheduling information provides a D2R transport block size (TBS),
determining the transmission of the PDRCH further includes determining whether to segment the PDRCH transmission into more than one transmission when an available amount of data at the IoT device is greater than the D2R TBS, and
transmitting the PDRCH further comprises transmitting the PDRCH in more than one transmission.

8. An Internet of Things (IoT) device, comprising:
a transceiver configured to receive a physical reader-to-device channel (PRDCH) from a reader, wherein the PRDCH provides information related to a physical device-to-reader channel (PDRCH) transmission including at least:
a preamble format to prepend to the PDRCH between a short format and a long format,
an interval for inserting one or more midambles in the PDRCH,
an indicator for appending an additional midamble at an end of the PDRCH, and
other device-to-reader (D2R) scheduling information; and
processing circuitry operably coupled with the transceiver, the processing circuitry configured to determine, based on reception of the PRDCH, a transmission of the PDRCH to the reader including:
the preamble format,
whether to insert the one or more midambles, and
whether to append the additional midamble,
wherein the transceiver is further configured to transmit, based on the determination, the PDRCH with a preamble and the one or more midambles.

9. The IoT device of claim 8, wherein the interval for inserting the one or more midambles in the PDRCH is provided as a number of bits after forward error correction (FEC) encoding.

10. The IoT device of claim 8, wherein:
the other D2R scheduling information includes an index from a set of code rates to encode the PDRCH with a forward error correction (FEC) code, and
the set of code rates includes a 1/3 code rate.

11. The IoT device of claim 8, wherein:
the other D2R scheduling information includes an index from a set of repetition factors for the PDRCH, and
the set of repetition factors is {1, 2}.

12. The IoT device of claim 8, wherein the other D2R scheduling information provides a D2R transport block size (TBS) in a unit of bytes.

13. The IoT device of claim 8, wherein:
the other D2R scheduling information provides a D2R transport block size (TBS), and
the processing circuitry is further configured to determine whether to insert padding bits when an available amount of data at the IoT device is smaller than the D2R TBS.

14. The IoT device of claim 8, wherein:
the other D2R scheduling information provides a D2R transport block size (TBS),
the processing circuitry is further configured to determine whether to segment the PDRCH transmission into more than one transmission when an available amount of data at the IoT device is greater than the D2R TBS, and
the transceiver is further configured to transmit the PDRCH in more than one transmission.

15. A reader, comprising:
a processor; and
a transceiver operably coupled with the processor, the transceiver configured to:
transmit a physical reader-to-device channel (PRDCH) to an Internet of Things (IoT) device, wherein:
the PRDCH provides information related to a physical device-to-reader channel (PDRCH) transmission including at least:
a preamble format to prepend to the PDRCH between a short format and a long format,
an interval for inserting one or more midambles in the PDRCH,
an indicator for appending an additional midamble at an end of the PDRCH, and
other device-to-reader (D2R) scheduling information, and
transmission of the PRDCH indicates, for the PDRCH:
the preamble format,
whether to insert the one or more midambles, and
whether to append the additional midamble; and
receive the PDRCH with a preamble and the one or more midambles.

16. The reader of claim 15, wherein the interval for inserting the one or more midambles in the PDRCH is provided as a number of bits after forward error correction (FEC) encoding.

17. The reader of claim 15, wherein:
the other D2R scheduling information includes an index from a set of code rates to encode the PDRCH with a forward error correction (FEC) code, and
the set of code rates includes a 1/3 code rate.

18. The reader of claim 15, wherein:
the other D2R scheduling information includes an index from a set of repetition factors for the PDRCH, and
the set of repetition factors is {1, 2}.

19. The reader of claim 15, wherein the other D2R scheduling information provides a D2R transport block size (TBS) in a unit of bytes.

20. The reader of claim 15, wherein:
the other D2R scheduling information provides a D2R transport block size (TBS), and
padding bits are included based on whether an available amount of data at the IoT device is smaller than the D2R TBS.
